(19) United States
(12) Patent Application Publication
(10) Pub. No.: US 2023/0136818 A1
(43) Pub. Date: May 4, 2023

(54) SOLID-STATE ELECTROCHEMICAL CELLS, PROCESSES FOR THEIR PREPARATION AND USES THEREOF

(71) Applicant: HYDRO-QUÉBEC, Montréal (CA)

(72) Inventors: Chisu KIM, Longueuil (CA); Ali DARWICHE, Lemoyne (CA); Benoit FLEUTOT, Boucherville (CA); Emmanuelle GARITTE, Montreal (CA); Ki Seok KOH, Longueuil (CA); Marc-Andre GIRARD, Montreal (CA); Catherine GAGNON, Sainte-Julie (CA); Karim ZAGHIB, Longueuil (CA)

(73) Assignee: HYDRO-QUÉBEC, Montréal, QC (CA)

(21) Appl. No.: 17/907,633

(22) PCT Filed: Apr. 27, 2021
(86) PCT No.: PCT/CA2021/050575

§ 371 Date: Sep. 28, 2022

Related U.S. Application Data
(60) Provisional application No. 63/015,952, filed on Apr. 27, 2020.

(51) Int. Cl. H01M 10/0565; H01M 4/36; H01M 4/62; H01M 4/587; H01M 4/525

(52) U.S. Cl. CPC H01M 10/0565; H01M 4/366; H01M 4/622; H01M 4/587; H01M 4/525; H01M 2300/0082; H01M 2004/028

(57) ABSTRACT

All-solid-state electrochemical cells comprising an inorganic particle-polymer composite, where the polymer is a crosslinked polymer and the content of inorganic particles in the composite is at least 50 wt. % are described. Also described are processes for the preparation of such all-solid-state electrochemical cells, all-solid-state batteries comprising them and their uses in mobile devices, electric or hybrid vehicles, or in renewable energy storage.

### RELATED APPLICATION

This application claims priority under applicable law to U.S. Provisional Patent Application No. 63/015,952 filed on Apr. 27, 2020, the content of which is incorporated herein by reference in its entirety and for all purposes.

### TECHNICAL FIELD

The present technology generally relates to the field of electrochemical cells comprising a composite material of ion-conducting inorganic particles and a crosslinked aprotic polymer, and their manufacturing processes.

### BACKGROUND

Lithium ion-conducting polymer electrolytes enable the development of safer and more affordable manufacturing processes, which are easily scaled up to large format all-solid-state batteries (for example, see U.S. Pat. No. 6,903,174). However, the low ionic conductivity limits its application at room temperature and results in relatively low charge/discharge rates compared to conventional lithium-ion batteries.

On the other hand, solid inorganic electrolytes are promising candidates for solid-state batteries, as they provide higher lithium-ion conductivity which is comparable to liquid electrolytes. In addition, the unique ion conduction property of inorganic electrolytes allows for lower concentration polarization at the lithium metal interface and enables high-speed battery charging and discharging. Despite its high ionic conductivity in the densified bulk phase, complete cells using ceramic solid electrolytes suffer from poor electrochemical performance due to significant interface resistance at the grain boundaries of the ceramic particles and between the particles of composite electrodes consisting of a mixture of active material particles, carbon additive and solid electrolyte. Since Li⁺ ion conduction must be carried out in a particles-to-particles mode, the electrochemical performance is limited by the poor distribution of solid electrolyte particles as well as by the existence of voids between the particles (see FIG. 1).

The group of K. Yoshima et al. described a hybrid electrolyte comprising LLZO particles and a gel polymer electrolyte in a composite cathode, which showed lower interface resistance and improved electrochemical performance. However, the presence of liquid electrolyte carries a risk of electrolyte leakage that may cause safety issues due to its flammability (see K. Yoshima et al., Journal of Power Sources, (2016), vol. 302, 283-290).

L. Cong et al. incorporated a low molecular weight PVdF-HFP polymer into LGPS (Li₁₀GeP₂S₁₂) particles, which improved the mechanical properties of the film and its processability, but the insulating polymer interferes with the conduction of Li⁺ ions and reduces the ionic conductivity of the hybrid solid electrolyte (see L. Cong et al., Journal of Power Sources, (2020), vol. 446, 227365).

D. Sugiura et al. used butadiene rubber as an additive to control the particle size of a solid sulfide ceramic and to form a self-supporting electrolyte film but, again, the presence of an insulating polymer increases the interfacial resistance and reduces the ionic conductivity (see US20140093785A1).

The group of J. Zhang et al. reported that adding 5-20 wt. % of poly(ethylene oxide) (POE) to argyrodite particles (Li₆PS₅X) improves the mechanical properties and stabilizes the electrolyte interface with a reduction in the formation of lithium dendrites (see J. Zhang et al., Journal of Power Sources, (2019), vol. 412, 78). However, the high molecular weight POE homopolymer used must be dissolved in large amounts of polar solvent. These conditions are not favorable for applications in a large-scale manufacturing process, and may cause technical problems such as particle sedimentation and increased porosity resulting from solvent evaporation.

Accordingly, there is a need for the development of new electrolytes and solid-state batteries and the development of processes for their production.

### SUMMARY

According to a first aspect, the present document relates to an all-solid-state electrochemical cell comprising a positive electrode comprising a positive electrode electrochemically active material, a negative electrode comprising a negative electrode electrochemically active material, and an electrolyte between the positive electrode and the negative electrode, wherein:
the positive electrode, the negative electrode and the electrolyte each form a solid layer; and
at least one of the positive electrode, the negative electrode and the electrolyte comprises a composite material comprising alkali or alkaline earth metal ion-conducting inorganic particles and a crosslinked aprotic polymer, and wherein:
   the content of inorganic particles in the composite material is in the range of 50 wt. % to 99.9 wt. %; and
   the crosslinked aprotic polymer is in solid form at 25° C. while its polymer precursor before crosslinking is in liquid form at 25° C.

In one embodiment, the inorganic particles comprise an ionically conducting inorganic compound of the amorphous, ceramic or glass-ceramic type, for example, selected from the oxide, sulfide or oxysulfide family. In another embodiment, the inorganic particles comprise a compound having a structure selected from garnets, NASICON, LISICON, thio-LISICON, LIPON, perovskite, anti-perovskite, argyrodites, or comprise a compound comprising the element combinations M-P—S, M-P—S—O, M-P—S—X, M-P—S—O—X, where M is an alkali or alkaline earth metal, and X is F, Cl, Br, I or a mixture thereof, the element combination optionally comprising one or more additional elements (metals, metalloids, or non-metals), the compound being in crystalline, amorphous, glass-ceramic form, or a mixture of at least two thereof.

In another embodiment, the inorganic particles comprise at least one of the compounds MLZO (such as M₇La₃Zr₂O₁₂, M₍₇₋ₐ₎La₃Zr₂Al_{b}O₁₂, M₍₇₋ₐ₎La₃Zr₂Ga_{b}O₁₂, M₍₇₋ₐ₎La₃Zr_{(2-b)}Ta_{b}O₁₂, M₍₇₋ₐ₎La₃Zr_{(2-b)}Nb_{b}O₁₂); MLTaO (such as M₇La₃Ta₂O₁₂, M₅La₃Ta₂O₁₂, M₆La₃Ta_{1.5}Y_{0.5}O₁₂); MLSnO (such as M₇La₃Sn₂O₁₂); MAGP (such as M₁₊ₐAlₐGe₂₋ₐ(PO₄)₃); MATP (such as M₁₊ₐAlₐTi₂₋ₐ(PO₄)₃); MLTiO (such as M₃ₐLa_{(2/3-a)}TiO₃); MZP (such as MₐZr_{b}(PO₄)_{c}); MCZP (such as MₐCa_{b}Zr_{c}(PO₄)_{d}); MGPS (such as MₐGe_{b}P_{c}S_{d}, for example, M₁₀GeP₂S₁₂); MGPSO (such as MₐGe_{b}P_{c}S_{d}Oₑ); MSiPS (such as MₐSi_{b}P_{c}S_{d}, for example, M₁₀SiP₂S₁₂); MSiPSO (such as MₐSi_{b}P_{c}S_{d}Oₑ); MSnPS (such as MₐSn_{b}P_{c}S_{d}, for example, M₁₀SnP₂S₁₂); MSnPSO (such as MₐSn_{b}P_{c}S_{d}Oₑ); MPS (such as MₐP_{b}S_{c}, for example, M₇P₃S₁₁); MPSO (such as MₐP_{b}S_{c}Od); MZPS (such as MₐZn_{b}P_{c}S_{d}); MZPSO (such as MₐZn_{b}P_{c}S_{d}Oₑ); xM₂S-yP₂S₅; xM₂S-yP₂S₅-zMX; xM₂S-yP₂S₅-zP₂O₅; xM₂S-yP₂S₅-zP₂O₅-wMX; xM₂S-yM₂O-zP₂S₅; xM₂S-yM₂O-zP₂S₅-wMX; xM₂S-yM₂O-zP₂S₅-wP₂O₅; xM₂S-yM₂O-zP₂S₅-wP₂O₅-vMX; xM₂S-ySiS₂; MPSX (such as MₐP_{b}S_{c}X_{d}, for example, M₇P₃S₁₁X, M₇P₂S₈X, M₆PS₅X); MPSOX (such as MₐP_{b}S_{c}O_{d}Xₑ); MGPSX (MₐGe_{b}P_{c}S_{d}Xₑ); MGPSOX (MₐGe_{b}P_{c}S_{d}OₑX_{f}); MSiPSX (MₐSi_{b}P_{c}S_{d}Xₑ); MSiPSOX (MₐSi_{b}P_{c}S_{d}OₑX_{f}); MSnPSX (MₐSn_{b}P_{c}S_{d}Xₑ); MSnPSOX (MₐSn_{b}P_{c}S_{d}OₑX_{f}); MZPSX (MₐZn_{b}P_{c}S_{d}Xₑ); MZPSOX (MₐZn_{b}P_{c}S_{d}OₑX_{f}); M₃OX; M₂HOX; M₃PO₄; M₃PS₄; or MₐPO_{b}N, (with a=2b+3c−5); in crystalline, amorphous, glass-ceramic form, or a mixture of at least two thereof;
wherein:
M is an alkali metal ion, an alkaline earth metal ion or a combination thereof, and wherein the number of M is adjusted to achieve electroneutrality when M comprises an alkaline earth metal ion;
X is F, Cl, Br, I, or a combination thereof;
a, b, c, d, e, and f are numbers other than zero and are, independently in each formula, selected to achieve electroneutrality; and
v, w, x, y, and z are numbers other than zero and are, independently in each formula, selected to obtain a stable compound.

In one embodiment, M is selected from Li, Na, K, Rb, Cs, Be, Mg, Ca, Sr, Ba, or a combination thereof, for example, M is lithium. Alternatively, M comprises Li and at least one of Na, K, Rb, Cs, Be, Mg, Ca, Sr, and Ba. According to other embodiments, M is Na, K, Rb, Cs, Be, Mg, Ca, Sr, Ba or a combination thereof, or M is Na, K, Mg, or a combination thereof.

In another embodiment, the crosslinked aprotic polymer is stable at >4V (vs. Li⁺/Li). In another embodiment, the crosslinked aprotic polymer comprises at least one aprotic polymer segment selected from polyether, polythioether, polyester, polythioester, polycarbonate, polythiocarbonate, polysiloxane, polyimide, polysulfonimide, polyamide, polysulfonamide, polyphosphazene, polyurethane segments, or a copolymer or combination of at least two thereof.

In one embodiment, the crosslinked aprotic polymer comprises at least one aprotic polymer segment comprising a block copolymer with at least two different repeating units to reduce the crystallinity of the crosslinked polymer. In another embodiment, the aprotic polymer segment comprises, before crosslinking, a block copolymer comprising at least one alkali or alkaline earth metal ion solvating segment and a crosslinkable segment comprising crosslinkable units. In one embodiment, the alkali or alkaline earth metal ion solvating segment is selected from homo- and copolymers comprising repeating units of Formula (I):

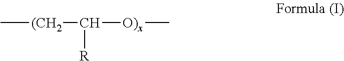

wherein,
R is selected from H, C₁-C₁₀alkyl, and —(CH₂—O—RₐR_{b});
Rₐ is (CH₂—CH₂—O)_{y}; and
R_{b} is a C₁-C₁₀alkyl group.

In another embodiment, the crosslinkable units comprise functional groups selected from acrylates, methacrylates, allyl, vinyl, and a combination thereof.

In one embodiment, the composite material forms the electrolyte layer and, for example, the crosslinked aprotic polymer is present between the inorganic particles.

In another embodiment, the electrolyte layer further comprises at least one salt, for example comprising a cation of an alkali or alkaline earth metal, and an anion selected from hexafluorophosphate (PF₆⁻), bis(trifluoromethanesulfonyl)imide (TFSI⁻), bis(fluorosulfonyl)imide (FSI⁻), (flurosulfonyl)(trifluoromethanesulfonyl)imide ((FSI)(TFSI)⁻), 2-trifluoromethyl-4,5-dicyanoimidazolate (TDI⁻), 4,5-dicyano-1,2,3-triazolate (DCTA⁻), bis(pentafluoroethylsulfonyl)imide (BETI⁻), difluorophosphate (DFP⁻), tetrafluoroborate (BF₄⁻), bis(oxalato)borate (BOB⁻), nitrate (NO₃⁻), chloride (Cl⁻), bromide (Br⁻), fluoride (F⁻), perchlorate (ClO₄⁻), hexafluoroarsenate (AsF₆⁻), trifluoromethanesulfonate (SO₃CF₃⁻) (Tf⁻), fluoroalkylphosphate [PF₃(CF₂CF₃)₃⁻] (FAP⁻), tetrakis(trifluoroacetoxy)borate [B(OCOCF₃)₄]⁻ (TFAB⁻), bis(1,2-benzenediolato(2-)-O,O′)borate [B(CsO₂)₂]⁻ (BBB⁻), difluoro(oxalato)borate (BF₂(C₂O₄)⁻) (FOB⁻), an anion of the formula BF₂O₄Rₓ (where Rₓ=C₂₋₄alkyl), and a combination thereof. In one embodiment, the alkali or alkaline earth metal cation of the salt is identical to the alkali or alkaline earth metal present in the inorganic particles.

In another embodiment, the electrolyte layer further comprises an ionic gel or liquid, for example, comprising a cation selected from imidazolium, pyridinium, pyrrolidinium, piperidinium, phosphonium, sulfonium and morpholinium cations, or from 1-ethyl-3-methylimidazolium (EMI), 1-methyl-1-propylpyrrolidinium (PY₁₃⁺), 1-butyl-1-methylpyrrolidinium (PY₁₄⁺), n-propyl-n-methylpiperidinium (PP₁₃⁺) and n-butyl-n-methylpiperidinium (PP₁₄⁺) cations, and an anion selected from PF₆⁻, BF₄⁻, AsF₆⁻, ClO₄⁻, CF₃SO₃—, (CF₃SO₂)₂N— (TFSI), (FSO₂)₂N⁻ (FSI), (FSO₂)(CF₃SO₂)N—, (C₂F₅SO₂)₂N⁻ (BETI), PO₂F₂⁻ (DFP), 2-trifluoromethyl-4,5-dicyanoimidazole (TDI), 4,5-dicyano-1,2,3-triazolate (DCTA), bis-oxalato borate (BOB), and (BF₂O₄Rₓ)⁻ (where Rₓ=C₂-C₄alkyl), wherein said ionic liquid is present in an amount such that the electrolyte layer remains in the solid state.

In another embodiment, the electrolyte layer further comprises an aprotic solvent having a boiling point higher than 150° C., for example, selected from ethylene carbonate (EC), propylene carbonate (PC), gamma-butyrolactone (γ-BL), poly(ethyleneglycol)dimethylether (PEGDME), dimethyl sulfoxide (DMSO), vinylene carbonate (VC), vinyl ethylene carbonate (VEC), 1,3-propylene sulfite, 1,3-propane sultone (PS), triethyl phosphate (TEPa), triethyl phosphite (TEPi), trimethyl phosphate (TMPa), trimethyl phosphite (TMPi), dimethyl methyl phosphonate (DMMP), diethyl ethyl phosphonate (DEEP), tris(trifluoroethyl) phosphate (TFFP), fluoroethylene carbonate (FEC), and a mixture thereof, and wherein said aprotic solvent is present in an amount such that the electrolyte layer remains in the solid state.

According to another embodiment, the positive electrode electrochemically active material present in the positive electrode layer comprises a metal oxide, metal sulfide, metal oxysulfide, metal phosphate, metal fluorophosphate, metal oxyfluorophosphate, metal sulfate, metal halide, sulfur, selenium, or a mixture of at least two thereof. In one embodiment, the metal of the metal oxide, metal sulfide, metal oxysulfide, metal phosphate, metal fluorophosphate, metal oxyfluorophosphate, metal sulfate, or metal halide comprises a metal selected from iron (Fe), titanium (Ti), manganese (Mn), vanadium (V), nickel (Ni), cobalt (Co), aluminum (AI), chromium (Cr), zirconium (Zr), niobium (Nb), and combinations of at least two thereof, optionally further comprising an alkali or alkaline earth metal. In one embodiment, the positive electrode electrochemically active material comprises a lithiated metal oxide, for example, a lithium nickel cobalt manganese oxide (NCM). In another embodiment, the positive electrode electrochemically active material comprises a lithiated metal phosphate, for example, lithiated iron phosphate (LiFePO₄).

In another embodiment, the positive electrode layer further comprises an electronically conducting material comprising at least one of carbon black (for example, Ketjenblack™ or Super P™) acetylene black (for example, Shawinigan black or Denka™ black), graphite, graphene, carbon fibers or nanofibers (for example, vapor grown carbon fibers (VGCFs)), carbon nanotubes (for example, single-wall (SWNT), multi-wall (MWNT)), or metal powders.

In another embodiment, the positive electrode layer comprises the composite material, for example, the crosslinked aprotic polymer being present between the inorganic particles and between the particles of the positive electrode electrochemically active material, and optionally of the electronically conducting material if present.

In another embodiment, the positive electrode layer further comprises a polymer binder selected from the crosslinked aprotic polymers as defined herein, fluorinated polymers (for example, PVDF, HFP, PTFE, and a copolymer or mixture of two or three thereof), polyvinylpyrrolidones (PVP), poly(styrene-ethylene-butylene) copolymers (SEB), and synthetic rubbers (for example, SBR (styrene butadiene rubber), NBR (acrylonitrile butadiene rubber), HNBR (hydrogenated NBR), CHR (epichlorohydrin rubber), ACM (acrylate rubber), EPDM (ethylene propylene diene monomer rubber), and combinations thereof, optionally further comprising a carboxyalkylcellulose, a hydroxyalkylcellulose, or a combination thereof).

According to another embodiment, the positive electrode layer further comprises at least one salt, for example, a salt as defined herein comprising a cation of an alkali or alkaline earth metal, preferably, the cation of an alkali or alkaline earth metal of the salt being identical to the alkali or alkaline earth metal present in the inorganic particles. In another embodiment, the positive electrode layer further comprises an ionic gel or liquid such as those described for the electrolyte layer. In another embodiment, the positive electrode layer further comprises an aprotic solvent having a boiling point higher than 150° C., for example, selected from those described herein. It is understood that the amount of the ionic liquid and/or the aprotic solvent is such that the positive electrode layer remains in the solid state.

According to one embodiment, the negative electrode electrochemically active material comprises a metallic film of an alkali or alkaline earth metal or an alloy comprising at least one thereof, for example, the alkali or alkaline earth metal is lithium or an alloy comprising lithium. In an alternative embodiment, the negative electrode electrochemically active material comprises a metallic film of a non-alkali and non-alkaline earth metal (such as In, Ge, Bi), or an alloy or intermetallic compound thereof (for example, SnSb, TiSnSb, Cu₂Sb, AlSb, FeSb₂, FeSn₂, CoSn₂). In one embodiment, the metallic film has a thickness in the range of 5 μm to 500 μm, preferably in the range of 10 μm to 100 μm.

In yet another embodiment, the negative electrode electrochemically active material is in the form of particles and has an oxidation-reduction potential lower than that of the positive electrode electrochemically active material. In one embodiment, the negative electrode electrochemically active material comprises a non-alkali or non-alkaline earth metal (such as In, Ge, Bi), an intermetallic compound (for example, SnSb, TiSnSb, Cu₂Sb, AlSb, FeSb₂, FeSn₂, CoSn₂), a metal oxide, a metal nitride, a metal phosphide, a metal phosphate (such as LiTi₂(PO₄)₃), a metal halide, a metal sulfide, a metal oxysulfide or a combination thereof, or a carbon (such as graphite, graphene, reduced graphene oxide, hard carbon, soft carbon, exfoliated graphite, and amorphous carbon), silicon (Si), silicon-carbon composite (Si—C), silicon oxide (SiOₓ), silicon oxide-carbon composite (SiOₓ—C), tin (Sn), tin-carbon composite (Sn—C), tin oxide (SnOₓ), tin oxide-carbon composite (SnOₓ—C) and a mixture thereof. In one embodiment, the metal oxide is selected from compounds of formulae M′_{b}OC (where M′ is Ti, Mo, Mn, Ni, Co, Cu, V, Fe, Zn, Nb or a combination thereof, and b and c are numbers such that the c:b ratio is in the range of 2 to 3, such as MoO₃, MoO₂, MoS₂, V₂O₅, and TiNb₂O₇), spinel oxides M′M″₂O₄ (such as NiCo₂O₄, ZnCo₂O₄, MnCo₂O₄, CuCo₂O₄, and CoFe₂O₄) and LiₐM′_{b}O_{c} (where M′ is Ti, Mo, Mn, Ni, Co, Cu, V, Fe, Zn, Nb or a combination thereof, such as a lithium titanate (such as Li₄Ti₅O₁₂) or a lithium molybdenum oxide (such as Li₂Mo₄O₁₃)).

According to one embodiment, the negative electrode layer further comprises an electronically conducting material such as those defined for the positive electrode layer.

In another embodiment, the negative electrode layer comprises the composite material, for example, the crosslinked aprotic polymer being present between the inorganic particles and between the particles of the negative electrode electrochemically active material, and of the electronically conducting material if present.

In other embodiments, the negative electrode layer further comprises a polymer binder selected from crosslinked aprotic polymers as defined herein, fluorinated polymers (such as PVDF, HFP, PTFE, and copolymers or mixtures of two or three thereof), polyvinylpyrrolidones (PVP), poly(styrene-ethylene-butylene) copolymers (SEB), and synthetic rubbers (such as SBR (styrene butadiene rubber), NBR (acrylonitrile butadiene rubber), HNBR (hydrogenated NBR), CHR (epichlorohydrin rubber), ACM (acrylate rubber), EPDM (ethylene propylene diene monomer rubber), and combinations thereof, optionally further comprising a carboxyalkylcellulose, a hydroxyalkylcellulose, or a combination thereof).

According to another embodiment, the negative electrode layer further comprises at least one salt as herein defined, for example comprising a cation of an alkali or alkaline earth metal, for example, the alkali or alkaline earth metal cation of the salt may be identical to the alkali or alkaline earth metal present in the inorganic particles. In another embodiment, the negative electrode layer further comprises an ionic liquid such as those defined herein. In another embodiment, the negative electrode layer further comprises an aprotic solvent having a boiling point higher than 150° C. It is understood that the amount of the ionic liquid and/or the aprotic solvent is such that the negative electrode layer remains in the solid state.

In some embodiments, the all-solid-state electrochemical cell further comprises an intermediate layer between the positive electrode layer and the electrolyte layer and/or between the negative electrode layer and the electrolyte layer. In one embodiment, the intermediate layer is an alkali or alkaline earth metal-ion conducting polymeric layer, a layer comprising alkali or alkaline earth metal-ion conducting inorganic particles or a combination thereof, preferably, the intermediate layer is an alkali or alkaline earth metal-ion conducting polymeric layer (for example, a lithium-ion conducting polymer).

According to a second aspect, the present document relates to a process for the preparation of an all-solid-state electrochemical cell as defined herein, said process comprising the steps of:
(i) preparing the positive electrode layer comprising the positive electrode electrochemically active material on a current collector
(ii) preparing the electrolyte layer;
(iii) preparing or providing the negative electrode layer comprising the negative electrode electrochemically active material, optionally on a current collector; and
(iv) assembling the all-solid-state electrochemical cell by combining the positive electrode layer, the electrolyte layer, and the negative electrode layer;
wherein steps (i) to (iii) are carried in any order and step (iv) is carried out after steps (i) to (iii), or simultaneously with one or two of steps (i) to (iii), or is partly carried out after two of steps (i) to (iii) have been carried out;
wherein at least one of steps (i), (ii) and (iii) further comprises mixing alkali or alkaline earth metal ion-conducting inorganic particles and a polymer precursor and optionally a solvent, wherein said polymer precursor is an aprotic polymer segment comprising crosslinkable units and is in liquid form at 25° C., and crosslinking the crosslinkable units of the polymer precursor, wherein the crosslinked polymer is in solid form at 25° C.; and
wherein the content of inorganic particles in the mixture of particles and polymer precursor is in the range of 50 wt. % to 99.9 wt. %.

In a first embodiment of the process, step (i) comprises preparing a positive electrode material mixture comprising the positive electrode electrochemically active material and applying it on a current collector; step (ii) comprises preparing an electrolyte composition and applying the composition on a support; the process comprising assembling the positive electrode layer and the electrolyte layer, and removing the support from the electrolyte layer before or after assembly with the positive electrode layer, optionally followed by the application of pressure and/or heat. In one embodiment, step (i) further comprises applying an intermediate layer on the positive electrode layer.

In a second embodiment of the process, step (i) comprises preparing a positive electrode material mixture comprising the positive electrode electrochemically active material and applying it on a current collector, optionally followed by application of an intermediate layer on the positive electrode layer; and step (ii) comprises preparing an electrolyte composition and applying the composition on the positive electrode layer or on the intermediate layer if present.

In a third embodiment of the process, step (ii) comprises preparing an electrolyte composition and applying the composition on a support; and step (i) comprises preparing a positive electrode material mixture comprising the positive electrode electrochemically active material and applying it on the electrolyte layer, optionally preceded by the application of an intermediate layer on the electrolyte layer, wherein the support is removed from the electrolyte layer before or after formation of the positive electrode.

In some embodiments of the first, second or third embodiment of the process, the negative electrode electrochemically active material:
comprises a metallic film and step (iii) comprises preparing the metallic film and applying it on the surface of the electrolyte layer opposite to the positive electrode layer, optionally further comprising the formation of an intermediate layer on the negative electrode layer or on the electrolyte layer before application; or
is in the form of particles and step (iii) comprises preparing a negative electrode material mixture comprising the negative electrode electrochemically active material and applying it on the surface of the electrolyte layer opposite to the positive electrode layer, optionally further comprising the formation of an intermediate layer on the electrolyte layer and applying the negative electrode material mixture on the intermediate layer; or
is in the form of particles and step (iii) comprises preparing a negative electrode material mixture comprising the negative electrode electrochemically active material and applying it on a current collector to form the negative electrode layer, and applying the negative electrode layer on the surface of the electrolyte layer opposite to the positive electrode layer, optionally further comprising the formation of an intermediate layer on the negative electrode layer or on the electrolyte layer before application.

In a fourth embodiment of the process, step (iii) comprises preparing a negative electrode material comprising the negative electrode electrochemically active material and optionally applying it on a current collector; step (ii) comprises preparing an electrolyte composition and applying the composition on a support, the process comprising assembling the negative electrode layer and the electrolyte layer, and removing the support from the electrolyte layer before or after assembly with the negative electrode layer, optionally followed by the application of pressure and/or heat.

In an embodiment, step (iii) further comprises applying an intermediate layer on the negative electrode layer.

In a fifth embodiment of the process, step (iii) comprises preparing a negative electrode material comprising the negative electrode electrochemically active material and optionally applying it on a current collector, optionally followed by forming an intermediate layer on the negative electrode layer; step (ii) comprising preparing an electrolyte composition and applying it on the negative electrode layer or on the intermediate layer if present.

In a sixth embodiment of the process, step (ii) comprises preparing an electrolyte composition and applying the composition on a support; and step (iii) comprises preparing a negative electrode material comprising the negative electrode electrochemically active material and applying it on the electrolyte layer, optionally preceded by applying an intermediate layer on the electrolyte layer or on the negative electrode layer, wherein the support is removed from the electrolyte layer before or after the formation of the negative electrode.

In some embodiments of the fourth, fifth or sixth embodiment of the process, step (i) comprises:
preparing a positive electrode material mixture comprising the positive electrode electrochemically active material and applying it on the surface of the electrolyte layer opposite to the negative electrode layer, optionally further comprising the formation of an intermediate layer on the electrolyte layer and applying the positive electrode material mixture on the intermediate layer; or
preparing a positive electrode material mixture comprising the positive electrode electrochemically active material and applying it on a current collector to form the positive electrode layer, and applying the positive electrode layer on the surface of the electrolyte layer opposite to the negative electrode layer, optionally further comprising the formation of an intermediate layer on the positive electrode layer or on the electrolyte layer before application.

In some embodiments of the fourth, fifth or sixth embodiment of the process, the negative electrode electrochemically active material comprises a metallic film and step (iii) comprises preparing the metallic film. In other embodiments of the fourth, fifth or sixth embodiment of the process, the negative electrode electrochemically active material comprises a material in the form of particles and step (iii) comprises preparing a negative electrode material mixture comprising the negative electrode electrochemically active material before application.

In one of the foregoing embodiments of the process, when the negative electrode electrochemically active material is in the form of particles, then the negative electrode material mixture may further comprise an electronically conducting material, and optionally a salt, an ionic liquid and/or an aprotic solvent. In one embodiment, the negative electrode material mixture further comprises a polymer binder. In another embodiment, the negative electrode material mixture further comprises the alkali or alkaline earth metal ion-conducting inorganic particles, the polymer precursor, and optionally a solvent, and step (iii) further comprises crosslinking the polymer precursor after application of the mixture. Alternatively, the negative electrode material mixture is a solid mixture further comprising the alkali or alkaline earth metal ion-conducting inorganic particles and step (iii) comprises applying the solid mixture, adding the polymer precursor and optionally a solvent on the applied solid mixture for dispersion of the polymer precursor between the particles, and crosslinking.

In one of the foregoing embodiments of the process, the electrolyte composition comprises a polymer or polymer precursor, and optionally a salt, an ionic liquid, and/or an aprotic solvent.

In one embodiment of any of the foregoing embodiments of the process, the electrolyte composition comprises the alkali or alkaline earth metal ion-conducting inorganic particles, the polymer precursor, and optionally a solvent, and step (ii) further comprises crosslinking the polymer precursor after application of the composition. Alternatively, the electrolyte composition is a solid composition comprising the alkali or alkaline earth metal ion-conducting inorganic particles, and step (ii) comprises applying the solid composition, adding the polymer precursor and optionally a solvent on the applied solid composition for the infiltration of the polymer precursor between the particles, and crosslinking the polymer precursor.

In another embodiment of any of the foregoing embodiments of the process, the positive electrode material mixture further comprises an electronically conducting material, and optionally a salt, an ionic liquid and/or an aprotic solvent. In one embodiment, the positive electrode material mixture further comprises a polymer binder. In another embodiment, the positive electrode material mixture further comprises the alkali or alkaline earth metal ion-conducting inorganic particles, the polymer precursor, and optionally a solvent, and step (iii) further comprises crosslinking the polymer precursor after application of the mixture. Alternatively, the positive electrode material mixture is a solid mixture further comprising the alkali or alkaline earth metal ion-conducting inorganic particles and step (iii) comprises applying the solid mixture, adding the polymer precursor and optionally a solvent on the applied solid mixture, for dispersing the polymer precursor between the particles, and crosslinking.

According to another embodiment, the process further comprises a photoinitiator, the crosslinking being carried out by UV irradiation, or a thermal initiator, the crosslinking being carried out by thermal treatment, or a combination thereof. In another embodiment, the crosslinking is carried out by electron beam or another energy source with or without the use of an initiator.

According to a third aspect, the present document relates to an all-solid-state battery comprising at least one of the present all-solid-state electrochemical cells. In one embodiment, the all-solid-state battery is a rechargeable battery. In another embodiment, the all-solid-state battery is a lithium battery or a lithium-ion battery. In yet another embodiment, the all-solid-state battery is for use in mobile devices, such as cell phones, cameras, tablets, or laptops, in electric or hybrid vehicles, or in renewable energy storage.

### BRIEF DESCRIPTION OF THE FIGURES

FIG. 1 (comparative) illustrates a solid-state battery comprising inorganic electrolyte particles without polymer electrolyte and without polymer binder.

FIG. 2 illustrates an embodiment of the present electrochemical cells comprising an electrolyte consisting of inorganic particles interconnected by a crosslinked polymer, a positive electrode layer comprising inorganic particles and a crosslinked polymer, and a metallic film is employed as a negative electrode material.

FIG. 3 illustrates an embodiment of the present electrochemical cells comprising a polymer electrolyte layer between the positive electrode and a metallic negative electrode, where the positive electrode layer comprises inorganic particles and a crosslinked polymer.

FIG. 4 illustrates another embodiment of the present electrochemical cells comprising an intermediate polymer layer between the positive electrode and electrolyte layers, each comprising inorganic particles and a crosslinked polymer, and a metallic film as a negative electrode material.

FIG. 5 illustrates one embodiment of the present electrochemical cells comprising an intermediate polymer layer between the positive electrode and electrolyte layers, each comprising inorganic particles and a crosslinked polymer, and a second intermediate polymer layer between the negative electrode and electrolyte layers, the negative electrode layer comprising a metallic film.

FIG. 6 illustrates another embodiment of the present electrochemical cells where each of the positive electrode layer and the electrolyte layer comprise the inorganic particles and the crosslinked polymer, and the cell comprises an intermediate polymer layer between the negative electrode layer and the electrolyte layer, the negative electrode layer comprising a metallic film.

FIG. 7 illustrates another embodiment of the present electrochemical cells where the negative electrode active material is in the form of particles and where the positive electrode layer, the electrolyte layer, and the negative electrode layer each comprise inorganic particles and a crosslinked polymer.

FIG. 8 shows the capacity retention results as a function of the number of cycles (cycle life) when cycled at 30° C. between 4.0V and 2.0V at a rate of C/12 for the solid-state battery of Example 1.

FIG. 9 shows the capacity retention results as a function of the number of cycles (cycle life) when cycled at 30° C. between 4.0V and 2.0V at a rate of C/6 or C/12 for the solid-state battery of Example 2.

FIG. 10 shows the scanning electron microscopy images of (a) the cross-section in secondary electron mode, and (b) the cross-section in backscattered electron mode, of the half-cell prepared in Example 3(b).

FIG. 11 shows the capacitance results for a charge and discharge cycle between 2.5V and 4.3V as a function of the applied current for the cell prepared in Example 3.

FIG. 12 shows the capacitance results for a charge and discharge cycle between 2.5V and 4.3V as a function of the applied current for the cell prepared in Example 4.

FIG. 13 shows the scanning electron microscopy images of (a) the surface (top), and (b) the cross-section, of the electrolyte layer prepared in Example 5.

FIG. 14 presents the ionic conductivity results as a function of the temperature for the electrolyte layer prepared in Example 5.

### DETAILED DESCRIPTION

All technical and scientific terms and expressions used herein have the same definition as those generally understood by the person skilled in the art of the present technology. The definition of some terms and expressions used herein is nevertheless provided below for clarity.

When the term “about” is used herein, it means approximately, in the region of, and around. When the term “about” is used in relation to a numerical value, it may modify it, for example, above and below by a 10% variation from its nominal value. This term may also take into account, for example, the experimental error specific to a measuring device or the rounding of a value.

When a range of values is mentioned in the present application, the lower and upper limits of the range are, unless otherwise specified, always included in the definition. When a range of values is mentioned in the present application, then all intermediate ranges and subranges, as well as the individual values included in the ranges of values, are included in the definition.

When the article “a” is used to introduce an element in the present application, it does not have the meaning of “only one”, but rather means “one or more”. Of course, where the specification states that a step, component, element, or particular feature “may” or “could” be included, that step, component, element, or particular feature is not required to be included in each embodiment.

The present document describes solid-state electrochemical cells comprising a positive electrode comprising a positive electrode electrochemically active material, a negative electrode comprising a negative electrode electrochemically active material, and an electrolyte between the positive electrode and the negative electrode, wherein the positive electrode, the negative electrode and the electrolyte are each in the form of a solid layer. The electrochemical cells are characterized in that at least one of the positive electrode, the negative electrode, and the electrolyte layer comprises a composite material as defined herein.

The composite material present in one or more of the above layers comprises ion-conducting inorganic particles of an alkali or alkaline earth metal and a crosslinked aprotic polymer, wherein the concentration of inorganic particles in the composite material is of at least 50 wt. %, for example, in the range of 50 wt. % to 99.9 wt. %; and the crosslinked aprotic polymer is in solid form at 25° C. while the polymer precursor before crosslinking is in liquid form at 25° C.

While the concentration of inorganic particles in the composite material is of at least 50 wt. % (for example, between 50 wt. % and 99.9 wt. %), other values within this range may be preferred depending on the inorganic particles used (for example, depending on particle size, surface area, etc.) and whether the composite is present in the electrolyte layer or as part of an electrode material. Non-limiting examples of inorganic particle concentration ranges comprise 50 wt. % to 80 wt. %, 60 wt. % to 80 wt. %, 55 wt. % to 75 wt. %, 70 wt. % to 99.9 wt. %, 80 wt. % to 99.9 wt. %, 75 wt. % to 90 wt. %, 65 wt. % to 85 wt. %, and other similar ranges.

For example, the inorganic particles may comprise an inorganic compound of oxide, sulfide, or oxysulfide type, or a compound having a structure selected from the garnet, NASICON, LISICON, thio-LISICON, LIPON, perovskite, anti-perovskite, argyrodite types, and/or may comprise a compound comprising the elements M-P—S, M-P—S—O, M-P—S—X, or M-P—S—O—X (where M is an alkali or alkaline earth metal, and X is F, Cl, Br, I or a mixture thereof) which may further comprise one or more additional elements (metals, metalloids, or non-metals) and may be in crystalline, amorphous, glass-ceramic form, or a mixture of at least two thereof.

Non-limiting examples of inorganic compounds forming the particles comprise MLZO (such as M₇La₃Zr₂O₁₂, M₍₇₋ₐ₎La₃Zr₂Al_{b}O₁₂, M₍₇₋ₐ₎La₃Zr₂Ga_{b}O₁₂, M₍₇₋ₐ₎La₃Zr_{(2-b)}Ta_{b}O₁₂, M₍₇₋ₐ₎La₃Zr_{(2-b)}NbbO₁₂); MLTaO (such as M₇La₃Ta₂O₁₂, M₅La₃Ta₂O₁₂, M₆La₃Ta_{1.5}Y_{0.5}O₁₂); MLSnO (such as M₇La₃Sn₂O₁₂); MAGP (such as M₁₊ₐAlₐGe₂₋ₐ(PO₄)₃); MATP (such as M₁₊ₐAlₐTi₂₋ₐ(PO₄)₃,); MLTiO (such as M₃ₐLa_{(2/3-a)}TiO₃); MZP (such as MₐZr_{b}(PO₄)_{c}); MCZP (such as MₐCa_{b}Zr_{c}(PO₄)_{d}); MGPS (such as MₐGe_{b}P_{c}S_{d}, for example, M₁₀GeP₂S₁₂); MGPSO (such as MₐGe_{b}P_{c}S_{d}Oₑ); MSiPS (such as MₐSi_{b}P_{c}S_{d}, for example, M₁₀SiP₂S₁₂); MSiPSO (such as MₐSi_{b}P_{c}S_{d}Oₑ); MSnPS (such as MₐSn_{b}P_{c}S_{d}, for example, M₁₀SnP₂S₁₂); MSnPSO (such as MₐSn_{b}P_{c}S_{d}Oₑ); MPS (such as MₐP_{b}S_{c}, for example, M₇P₃S₁₁); MPSO (such as MₐP_{b}S_{c}O_{d}); MZPS (such as MₐZn_{b}P_{c}S_{d}); MZPSO (such as MₐZn_{b}P_{c}S_{d}Oₑ); xM₂S-yP₂S₅; xM₂S-yP₂S₅-zMX; xM₂S-yP₂S₅-zP₂O₅; xM₂S-yP₂S₅-zP₂O₅-wMX; xM₂S-yM₂O-zP₂S₅; xM₂S-yM₂O-zP₂S₅-wMX; xM₂S-yM₂O-zP₂S₅-wP₂O₅; xM₂S-yM₂O-zP₂S₅-wP₂O₅-vMX; xM₂S-ySiS₂; MPSX (such as MₐP_{b}S_{c}X_{d}, for example, M₇P₃S₁₁X, M₇P₂S₈X, M₆PS₅X); MPSOX (such as MₐP_{b}S_{c}O_{d}Xₑ); MGPSX (such as MₐGe_{b}P_{c}S_{d}Xₑ); MGPSOX (such as MₐGe_{b}P_{c}S_{d}OₑX_{f}); MSIPSX (such as MₐSi_{b}P_{c}S_{d}Xₑ); MSiPSOX (such as MₐSi_{b}P_{c}S_{d}OₑX_{f}); MSnPSX (such as MₐSn_{b}P_{c}S_{d}Xₑ); MSnPSOX (such as MₐSn_{b}P_{c}S_{d}OₑX_{f}); MZPSX (such as MₐZn_{b}P_{c}S_{d}Xₑ); MZPSOX (such as MₐZn_{b}P_{c}S_{d}OₑX_{f}); M₃OX; M₂HOX; M₃PO₄; M₃PS₄; MₐPO_{b}N_{c} (with a=2b+3c−5); in crystalline, amorphous, glass-ceramic form, or a mixture of at least two thereof, wherein M is an alkali metal ion, an alkaline earth metal ion, or a combination thereof, and wherein when M comprises an alkali metal ion, then the number of M is adjusted to achieve electroneutrality; X is F, Cl, Br, I or a combination thereof; a, b, c, d, e and f are numbers other than zero and are, independently in each formula, selected to achieve electroneutrality; and v, w, x, y, and z are numbers other than zero and are, independently in each formula, selected to obtain a stable compound.

For example, the alkali or alkaline earth metal (M) is selected from Li, Na, K, Rb, Cs, Be, Mg, Ca, Sr, Ba or a combination thereof. According to one example, M is lithium or a combination of Li and at least one of Na, K, Rb, Cs, Be, Mg, Ca, Sr, and Ba. Alternatively, M is Na, K, Rb, Cs, Be, Mg, Ca, Sr, Ba or a combination of at least two thereof, for example, M is Na, K, Mg, or a combination of at least two thereof.

In the composite, the crosslinked aprotic polymer is generally prepared from a polymer precursor in the form of an aprotic polymer segment comprising heteroatoms (for example, O, N, P, S, Si, etc.) and crosslinkable units. The crosslinked polymer is solid at room temperature and has a glass transition temperature T_{g} of −40° C. or less. The polymer preferably exhibits high chain flexibility to facilitate lithium-ion transfer.

The crosslinked aprotic polymer is preferably electrochemically stable at 4V and above (vs. Li⁺/Li) and/or is compatible with high-capacity positive electrode materials (>150 mAh/g). The crosslinked aprotic polymer preferably comprises an aprotic polymer segment such as a polyether, polythioether, polyester, polythioester, polycarbonate, polythiocarbonate, polysiloxane, polyimide, polysulfonimide, polyamide, polysulfonamide, polyphosphazene, polyurethane, or a copolymer or mixture thereof. For example, the aprotic polymer segment comprises a block copolymer with different repeating units to reduce the crystallinity of the polymer after crosslinking. In some examples, the aprotic polymer segment comprises, before crosslinking, a block copolymer consisting of at least one alkali or alkaline earth metal ion solvating segment and at least one crosslinkable segment comprising crosslinkable units. For example, the alkali or alkaline earth metal ion solvating segment is selected from homo- and copolymers comprising repeating units of Formula (I):

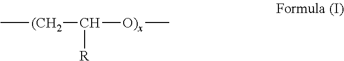

wherein,
R is selected from H, C₁-C₁₀alkyl, or —(CH₂—O—RₐR_{b});
Rₐ is (CH₂—CH₂—O)_{y}; and
R_{b} is a C₁-C₁₀alkyl group.

The crosslinkable units generally include unsaturated bonds, which may be crosslinked after film casting. The polymer may comprise more than one crosslinkable functional group in order to form a multidimensional network after crosslinking including multi-branched or hyper-branched networks. Examples of functional groups present in crosslinkable units include at least one group selected from acrylates, methacrylates, allyls, and vinyls.

Branches of the polymer may also comprise graft copolymers containing block copolymer segments. The copolymer may also further comprise non-solvating segments which may improve the mechanical strength of the film.

As mentioned above, the aprotic polymer is in liquid phase at room temperature before crosslinking, which facilitates its insertion into the particles network of the electrolyte, at the electrode/electrolyte interface and/or within the electrode material without the use of substantial amounts of additional solvent. The pores between the inorganic particles (and of the electrode material in the case of electrodes) are filled with the polymer precursor in the liquid phase before crosslinking. The average molecular weight of the polymer precursor is preferably in the range of 250 to 50,000 g/mol before crosslinking.

The electrolyte may consist of a layer of the composite material or it may comprise the composite material and additional components. Alternatively, when the composite material is present in one of the electrodes, the electrolyte layer may be a solid polymer electrolyte layer, for example, comprising a crosslinked aprotic polymer as defined herein, and optionally additional components. The electrolyte layer may further comprise at least one alkali or alkaline earth metal salt. Non-limiting examples of salts comprise an alkali or alkaline earth metal cation, and an anion selected from hexafluorophosphate (PF₆⁻), bis(trifluoromethanesulfonyl)imide (TFSI⁻), bis(fluorosulfonyl)imide (FSI⁻), (flurosulfonyl)(trifluoromethanesulfonyl)imide ((FSI)(TFSI)⁻), 2-trifluoromethyl-4,5-dicyanoimidazolate (TDI⁻), 4,5-dicyano-1,2,3-triazolate (DCTA⁻), bis(pentafluoroethylsulfonyl)imide (BETI⁻), difluorophosphate (DFP⁻), tetrafluoroborate (BF₄⁻), bis(oxalato)borate (BOB⁻), nitrate (NO₃⁻), chloride (Cl⁻), bromide (Br⁻), fluoride (F⁻), perchlorate (ClO₄⁻), hexafluoroarsenate (AsF₆⁻), trifluoromethanesulfonate (SO₃CF₃⁻) (Tf⁻), fluoroalkylphosphate [PF₃(CF₂CF₃)₃⁻] (FAP⁻), tetrakis(trifluoroacetoxy)borate [B(OCOCF₃)₄]⁻ (TFAB⁻), bis(1,2-benzenediolato (2-)-O,O′)borate [B(C₆O₂)₂]⁻ (BBB⁻), difluoro(oxalato)borate (BF₂(C₂O₄)⁻) (FOB⁻), a compound of formula BF₂O₄Rₓ (Rₓ=C₂₋₄alkyl), and a combination of at least two thereof. For example, the molar ratio of heteroatom of the aprotic polymer:alkali or alkaline earth metal ion of the salt may be in the range of 4:1 to 50:1, preferably in the range of 10:1 to 30:1. In some preferred examples, the alkali or alkaline earth metal forming cation of the salt is identical to an alkali or alkaline earth metal present in the inorganic particles.

The present electrolyte may also further comprise at least one ionic liquid. Non-limiting examples of ionic liquids comprise a cation selected from imidazolium, pyridinium, pyrrolidinium, piperidinium, phosphonium, sulfonium and morpholinium, or a cation selected from 1-ethyl-3-methylimidazolium (EMI), 1-methyl-1-propylpyrrolidinium (PY₁₃⁺), 1-butyl-1-methylpyrrolidinium (PY₁₄⁺), n-propyl-n-methylpiperidinium (PP₁₃⁺) and n-butyl-n-methylpiperidinium (PP₁₄⁺), and an anion selected from PF₆⁻, BF₄⁻, AsF₆⁻, ClO₄⁻, CF₃SO₃⁻, (CF₃SO₂)₂N⁻ (TFSI), (FSO₂)₂N⁻ (FSI), (FSO₂)(CF₃SO₂)N⁻, (C₂F₅SO₂)₂N⁻ (BETI), PO₂F₂⁻ (DFP), 2-trifluoromethyl-4,5-dicyanoimidazole (TDI), 4,5-dicyano-1,2,3-triazolate (DCTA), bis-oxalato borate (BOB), and (BF₂O₄Rₓ)⁻ (Rₓ=C₂-C₄ alkyl), wherein the ionic liquid is present in an amount such that the electrolyte layer remains solid (for example, less than 30 wt. %, or less than 20 wt. %, or less than 10 wt. % of the solid layer of the electrolyte).

An aprotic solvent having a boiling point higher than 150° C. may also be included in the electrolyte. Examples of such aprotic solvents include ethylene carbonate (EC), propylene carbonate (PC), gamma-butyrolactone (γ-BL), poly(ethyleneglycol)dimethylether (PEGDME), dimethyl sulfoxide (DMSO), vinylene carbonate (VC), vinyl ethylene carbonate (VEC), 1,3-propylene sulfite, 1,3-propane sultone (PS), triethyl phosphate (TEPa), triethyl phosphite (TEPi), trimethyl phosphate (TMPa), trimethyl phosphite (TMPi), dimethyl methyl phosphonate (DMMP), diethyl ethyl phosphonate (DEEP), tris(trifluoroethyl) phosphate (TFFP), fluoroethylene carbonate (FEC), or a mixture thereof wherein the aprotic solvent is present in an amount such that the electrolyte layer remains solid (for example, less than 30 wt. %, or less than 20 wt. %, or less than 10 wt. % of the solid layer of the electrolyte).

The positive electrode layer preferably comprises an electrode material on a current collector, wherein the material comprises at least one electrochemically active material. Non-limiting examples of positive electrode electrochemically active materials comprise a metal oxide, metal sulfide, metal oxysulfide, metal phosphate, metal fluorophosphate, metal oxyfluorophosphate, metal sulfate, metal halide, sulfur, selenium, or a mixture of at least two thereof. For example, the metal oxide, metal sulfide, metal oxysulfide, metal phosphate, metal fluorophosphate, metal oxyfluorophosphate, metal sulfate, or metal halide comprises a metal selected from the elements iron (Fe), titanium (Ti), manganese (Mn), vanadium (V), nickel (Ni), cobalt (Co), aluminum (AI), chromium (Cr), zirconium (Zr), niobium (Nb), and a combination of at least two thereof. In some examples, the metal further comprises an alkali or alkaline earth metal (for example, lithium). In one preferred example, the positive electrode electrochemically active material comprises a lithiated metal oxide, for example, a lithiated nickel cobalt manganese oxide (NCM). In another preferred example, the positive electrode electrochemically active material comprises a lithiated metal phosphate, for example a lithiated iron phosphate (LiFePO₄).

The positive electrode may also include additional elements such as one or more electronically conducting materials, binders, and/or inorganic ion-conducting materials (for example, alkali or alkaline earth metal ion conductor). Examples of electronically conducting material comprise, without limitation, carbon black (such as Ketjenblack™ and Super P™) acetylene black (such as Shawinigan black and Denka™ black), graphite, graphene, carbon fibers or nanofibers (for example, vapor grown carbon fibers (VGCFs)), carbon nanotubes (for example, single-wall (SWNT), multi-wall (MWNT)), or metal powders.

In some cases, the positive electrode material comprises the composite as herein described, the crosslinked aprotic polymer serving as a binder and being present between the inorganic particles and between the particles of the positive electrode electrochemically active material.

Alternatively, the positive electrode layer further comprises a polymer binder selected from crosslinked aprotic polymers as defined herein, fluorinated polymers (such as PVDF, HFP, PTFE, or a copolymer or mixture of at least two thereof), polyvinylpyrrolidones (PVP), poly(styrene-ethylene-butylene) copolymers (SEB), and synthetic rubbers (for example, SBR (styrene butadiene rubber), NBR (acrylonitrile butadiene rubber), HNBR (hydrogenated NBR), CHR (epichlorohydrin rubber), ACM (acrylate rubber), EPDM (ethylene propylene diene monomer rubber), and the like, optionally further comprising a carboxyalkylcellulose or hydroxyalkylcellulose).

Optionally, the positive electrode layer may also further comprise a salt, an ionic liquid and/or a high boiling aprotic solvent as defined herein.

In some embodiments, the negative electrode electrochemically active material comprises a metallic film. For example, the metallic film is a film of an alkali or alkaline earth metal or an alloy comprising the same, such as a film of lithium or an alloy thereof. Alternatively, the metallic film is made of a non-alkali and non-alkaline earth metal (for example, In, Ge, Bi), or an alloy or intermetallic compound (such as SnSb, TiSnSb, Cu₂Sb, AlSb, FeSb₂, FeSn₂, CoSn₂). Preferably, the metallic film has a thickness of 5 μm to 500 μm, preferably 10 μm to 100 μm.

In other embodiments, the negative electrode electrochemically active material comprises a particulate material having an oxidation-reduction potential lower than that of the positive electrode electrochemically active material. Non-limiting examples of negative electrode electrochemically active material comprise a non-alkali and non-alkaline earth metal (for example, In, Ge, Bi), an intermetallic compound (such as SnSb, TiSnSb, Cu₂Sb, AlSb, FeSb₂, FeSn₂, CoSn₂), a metal oxide, a metal nitride, a metal phosphide, a metal phosphate (such as LiTi₂(PO₄)₃), a metal halide, a metal sulfide, a metal oxysulfide, or a combination thereof, or a carbon (such as graphite, graphene, reduced graphene oxide, hard carbon, soft carbon, exfoliated graphite, and amorphous carbon), silicon (Si), a silicon-carbon composite (Si—C), silicon oxide (SiOₓ), silicon oxide-carbon composite (SiOₓ—C), tin (Sn), tin-carbon composite (Sn—C), tin oxide (SnOₓ), tin oxide-carbon composite (SnOₓ—C), or a mixture thereof. Examples of metal oxides comprise, without limitation, compounds of formula M′_{b}OC (where M′ is Ti, Mo, Mn, Ni, Co, Cu, V, Fe, Zn, Nb or a combination thereof, and where b and c are numbers such that the ratio of c to b is 2 to 3, such as MoO₃, MoO₂, MoS₂, V₂O₅, and TiNb₂O₇), spinel oxides of formula M′M″₂O₄ (such as NiCo₂O₄, ZnCo₂O₄, MnCo₂O₄, CuCo₂O₄, and CoFe₂O₄) and oxides of formula LiₐM′_{b}O_{c} (where M′ is Ti, Mo, Mn, Ni, Co, Cu, V, Fe, Zn, Nb or combination thereof, such as a lithium titanate (for example, Li₄Ti₅O₁₂) or a lithium molybdenum oxide (for example, Li₂Mo₄O₁₃)).

When the negative electrode electrochemically active material is the form of particles, the negative electrode may also comprise additional elements such as electronically conducting materials, binders, and/or inorganic lithium ion-conducting materials. Examples of possible electronically conducting materials and binders are as defined above with respect to the positive electrode material. Optionally, the negative electrode layer may also comprise a salt, an ionic liquid, and/or a high boiling aprotic solvent as defined herein.

In some examples, the negative electrode material comprises the present composite, the crosslinked aprotic polymer serving as a binder and being present between the inorganic particles and between the particles of the negative electrode electrochemically active material.

The present electrochemical cell may also further include an intermediate layer between the electrolyte layer and the positive electrode layer, between the electrolyte layer and the negative electrode layer, or between the electrolyte layer and each of the positive electrode layer and the negative electrode layer. Such an intermediate layer is a solid film, preferably having a thickness lower than that of the electrolyte layer, and comprises an alkali or alkaline earth metal ion-conducting polymeric layer or a film comprising an alkali or alkaline earth metal ion-conducting inorganic layer or a combination thereof. In one preferred embodiment, the intermediate layer is an alkali or alkaline earth metal ion-conducting polymeric layer (for example, a lithium ion-conducting polymer). The role of the intermediate layer may comprise protecting the electrode material from the electrolyte or the electrolyte layer from the electrode material, or to promote adhesion between the electrode layer and the electrolyte layer. This intermediate layer should possess alkali or alkaline earth metal ion conduction and electron tunneling resistance properties.

The present all-solid-state electrochemical cell is preferably prepared by a process comprising the steps of:
(i) preparing a solid positive electrode layer comprising a positive electrode electrochemically active material on a current collector;
(ii) preparing a solid electrolyte layer;
(iii) preparing or providing a solid negative electrode layer comprising a negative electrode electrochemically active material, optionally on a current collector; and
(iv) assembling the solid-state electrochemical cell by combining the solid positive electrode layer, the solid electrolyte layer, and the solid negative electrode layer.

Steps (i) to (iii) may be carried out in any order and step (iv) is carried out after steps (i) to (iii), or simultaneously with one or two of steps (i) to (iii), or is partially carried out after two of steps (i) to (iii) have been completed.

In this process, at least one of steps (i), (ii), and (iii) further comprises mixing alkali or alkaline earth metal ion-conducting inorganic particles and a polymer precursor and optionally a solvent, wherein the polymer precursor is an aprotic polymer segment comprising crosslinkable units and is in a liquid state at 25° C. The process further comprises a step of crosslinking the crosslinkable units of the polymer precursor to obtain a crosslinked polymer in solid form at 25° C. The concentration of inorganic particles in the mixture of particles and polymer precursor is in the range of 50 wt. % to 99.9 wt. %.

According to one alternative, each of the solid positive electrode layer, the solid electrolyte layer, and the solid negative electrode layer are formed separately, and the three layers are assembled together at once, or one of the electrode layers and the electrolyte layer are assembled together followed by the other electrode layer on the free surface of the electrolyte layer. The formation of the electrolyte layer may involve the use of a support, which may be removed afterwards or may serve as an intermediate layer between the electrolyte and one of the electrodes. Such a process involving the formation of the layers independently may further comprise pressing two or three layers together with or without heating.

Alternatively, a multilayer material may be prepared by forming a first layer (electrode or electrolyte) followed by the direct application of a second layer (electrolyte or electrode) onto the first layer.

The layers are formed by following the above steps (i), (ii) and (iii) and/or as exemplified below.

For example, step (ii) comprises preparing an electrolyte composition and applying the resulting mixture. The electrolyte composition comprises a polymer or polymer precursor, and optionally a salt, an ionic liquid and/or an aprotic solvent and the application is followed by drying and/or crosslinking of the applied mixture. The electrolyte composition may also comprise the alkali or alkaline earth metal ion-conducting inorganic particles, the polymer precursor, and optionally a solvent as defined herein, and step (ii) further comprises crosslinking the polymer precursor after application of the composition; or the electrolyte composition is a solid composition comprising the alkali or alkaline earth metal ion-conducting inorganic particles, and step (ii) comprises adding the polymer precursor and optionally a solvent on the applied solid composition for infiltration of the precursor between the particles and crosslinking of the polymer precursor. The electrolyte composition may be applied on a substrate before assembly with or application of the positive or negative electrode on the preformed electrolyte layer. Alternatively, the electrolyte composition is applied on the positive electrode layer or the negative electrode layer or on an intermediate layer (to be disposed between the electrolyte layer and the electrode layer). The other electrode layer (positive or negative) is then formed on the electrolyte layer or is preformed on a current collector and assembled with the electrolyte. An intermediate layer may also be applied on the electrolyte layer or on the electrode before assembly.

Step (i) generally comprises preparing a positive electrode material mixture comprising the positive electrode electrochemically active material and applying it on a current collector, an intermediate layer, or on the solid electrolyte layer (as explained above). The positive electrode material mixture may further comprise an electronically conducting material, and optionally a binder, a salt, an ionic liquid, and/or an aprotic solvent as defined herein. For example, the positive electrode material mixture further comprises the alkali or alkaline earth metal ion-conducting inorganic particles, the polymer precursor, and optionally a solvent, and the process further comprises a step of crosslinking the polymer precursor after application of the mixture; or the positive electrode material mixture is a solid mixture further comprising the alkali or alkaline earth metal ion-conducting inorganic particles and the process comprises applying the solid mixture, adding the polymer precursor and optionally a solvent on the applied solid mixture for dispersion between the particles, and crosslinking.

In one example, the negative electrode electrochemically active material comprises a metallic film and step (iii) comprises preparing the metallic film as defined herein.

According to another example, the negative electrode electrochemically active material comprises a particulate material and step (iii) comprises preparing a negative electrode material mixture comprising the negative electrode electrochemically active material before application. The negative electrode material mixture may also comprise an electronically conducting material, and optionally a binder, a salt, an ionic liquid, and/or an aprotic solvent. The negative electrode material mixture may further comprise alkali or alkaline earth metal ion-conducting inorganic particles, a polymer precursor, and optionally a solvent, and step (iii) further comprises crosslinking the polymer precursor after application of the mixture. Alternatively, the negative electrode material mixture is a solid mixture further comprising the alkali or alkaline earth metal ion-conducting inorganic particles and step (iii) comprises applying the solid mixture, adding the polymer precursor and optionally a solvent on the applied solid mixture for dispersion between the particles, and crosslinking.

In the above process, the polymer to be crosslinked may further comprise a photoinitiator and the crosslinking may be carried out by UV irradiation, or comprise a thermal initiator and the crosslinking may be carried out by heat treatment, or a combination thereof. Alternatively, the crosslinking is carried out by electron beam or another energy source with or without the use of an initiator.

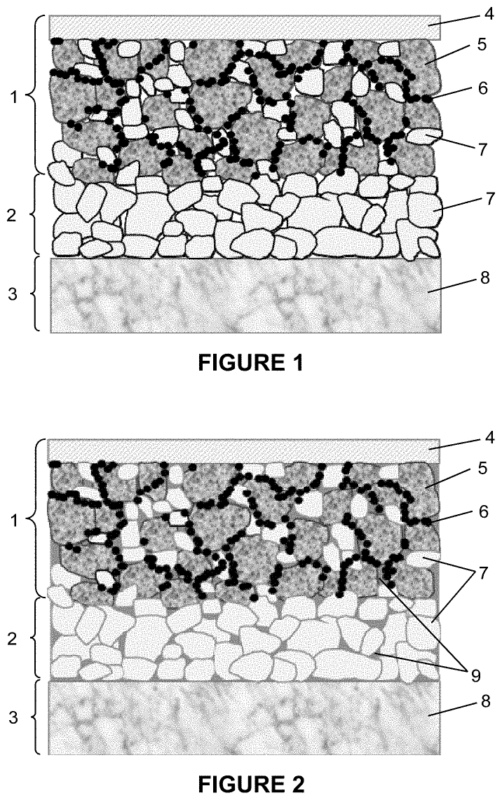

FIG. 1 illustrates, for comparison purposes, a possible configuration for all-solid-powder cells. This example comprises a positive electrode layer (1) containing positive electrode electrochemically active material particles (5), an electronically conducting material (6), and inorganic particles (7) on a current collector (4). The electrolyte layer (2) comprises inorganic particles (7) and the negative electrode layer (3) comprises a metallic film (8). The contact between the particles is ensured only under maintained compression.

FIG. 2 illustrates a possible configuration for the present cells, where the composite material is present in the positive electrode layer and in the electrolyte. This example comprises a positive electrode layer (1) containing positive electrode electrochemically active material particles (5), an electronically conducting material (6), inorganic particles (7) and a crosslinked aprotic polymer (9) on a current collector (4). The electrolyte layer (2) comprises the composite consisting of inorganic particles (7) and crosslinked aprotic polymer (9). In this example, the negative electrode layer (3) comprises a metallic film (8). Since the polymer precursor is liquid before crosslinking, the crosslinked aprotic polymer is found within the pores, thus forming a network of particles interconnected by the polymer in the positive electrode and electrolyte layers. The polymer precursor may be added to the slurry (for example, the positive electrode slurry) before application or it may be infiltrated into the pores after the formation of dry solid films. The positive electrode and electrolyte films may be casted separately, followed by pressure and heat lamination. Preferably, the electrolyte slurry may be casted directly onto the dry positive electrode to form the electrolyte layer.

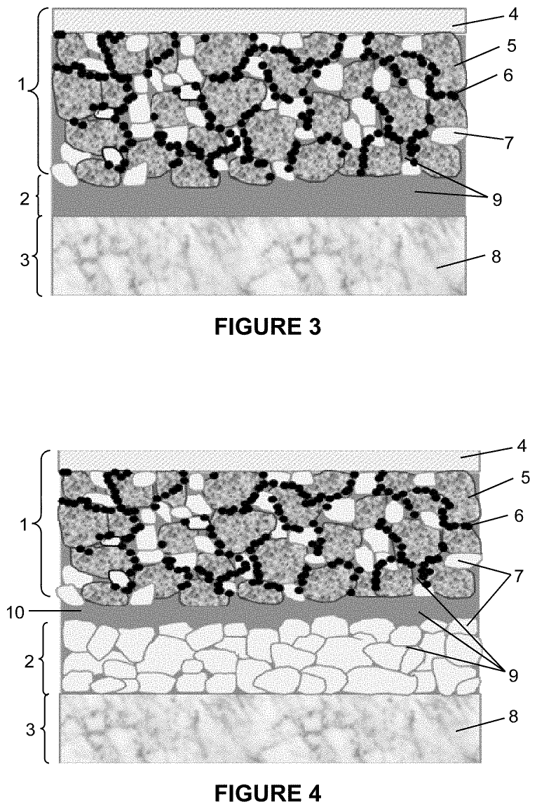

FIG. 3 shows another configuration of the present cells, where the composite is present in the positive electrode layer and the electrolyte consists of a crosslinked aprotic polymer layer (9), preferably containing at least one salt. In this case, the polymer electrolyte layer (2) may be applied on the positive electrode layer (1) comprising the positive electrode electrochemically active material (5), an electronically conducting material (6) such as carbon, and the inorganic particles (7) as defined herein. The polymer then forms a thin polymer electrolyte layer between the positive electrode and the metallic film (8) of the negative electrode material. The solid layer of crosslinked polymer electrolyte generally has a thickness in the range of about 3 μm to about 100 μm, preferably in the range of about 5 μm to about 30 μm. The polymer found inside the positive electrode layer acts as a binder and may be added in the slurry preparation step (mixing) or infiltrated into the pores inside the porous film of the positive electrode layer at the time the electrolyte layer overcoating is carried out.

FIG. 4 shows a configuration where an intermediate layer (10) (such as a protective layer) is inserted between the electrolyte layer (2) and the positive electrode layer (1). The intermediate layer in this example is a film of the crosslinked aprotic polymer (9) and may further comprise at least one salt as defined herein. This intermediate layer may be formed on the positive electrode layer or on the electrolyte layer before formation of the other layer and may improve the adhesiveness and reduce the interface resistance between the positive electrode layer and the hybrid electrolyte layer.

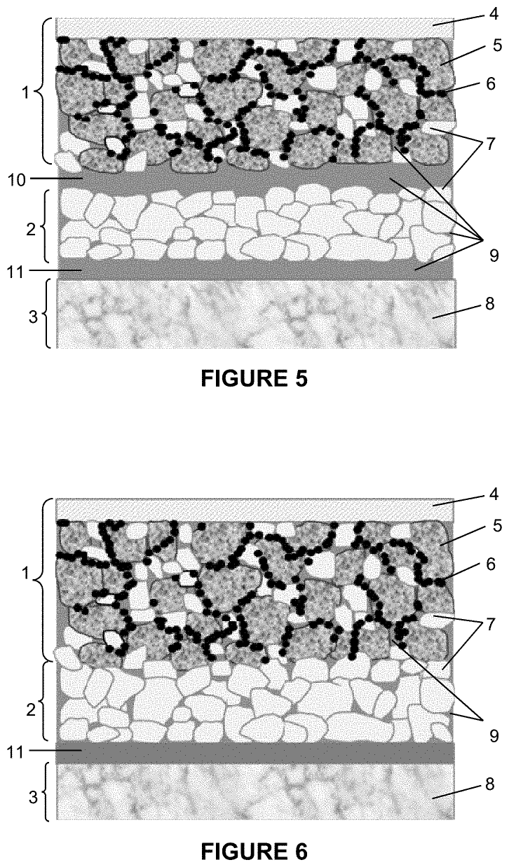

FIG. 5 illustrates a configuration where an intermediate layer (10) is inserted between the electrolyte layer (2) and the positive electrode layer, and an intermediate layer (11) is inserted between the electrolyte layer (2) and the negative electrode layer. The intermediate layers in this example are films of the crosslinked aprotic polymer (9) and may further comprise at least one salt as defined herein. However, the intermediate layer (10) and the intermediate layer (11) may also be different. Preferably, the intermediate layer (10) has a high oxidation stability at >4V and the intermediate layer (11) in contact with the negative electrode demonstrates a high reduction stability against the negative electrode metallic material (8) used. These intermediate layers may be formed by application on the electrode layers or the electrolyte layer before the formation of the other layers.

FIG. 6 shows a configuration where an intermediate layer (11) is inserted between the electrolyte layer and the negative electrode layer. The intermediate layer in this example may be a film of the crosslinked aprotic polymer and further comprise at least one salt as defined herein or may be composed of a dense inorganic material different from the inorganic particles of the electrolyte. The intermediate layer generally possesses an ionic conductivity to an alkali or alkaline earth metal while having a high resistance to electronic tunneling. The intermediate layer may be formed on the negative electrode layer or on the electrolyte layer before formation or assembly with the other layer.

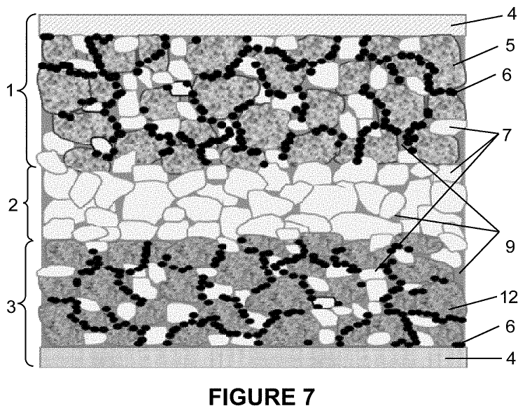

FIG. 7 illustrates the configuration of an example of the present cells, where the composite material is present in the positive electrode layer, the electrolyte layer and the negative electrode layer. This example comprises a positive electrode layer (1) comprising positive electrode electrochemically active material particles (5), electronically conducting material (6), inorganic particles (7), and the crosslinked aprotic polymer (9) on a current collector (4). The electrolyte layer (2) comprises the composite consisting of inorganic particles (7) and the crosslinked aprotic polymer (9). The negative electrode layer (3) comprises negative electrode electrochemically active material particles (12) as defined herein, an electronically conducting material (6), inorganic particles (7) and the crosslinked aprotic polymer (9) on a current collector (4) which may be made of a different material than that of the positive electrode. The crosslinked aprotic polymer is then present within the pores of the whole cell, thus forming a network of particles interconnected by the polymer in all elements. The polymer precursor may be added to the slurry (for example, of the positive or negative electrode) before application or it may be infiltrated into the pores of previously prepared dry solid films. The electrode films and electrolyte films may be casted separately, followed by lamination under pressure and heat. Preferably, the electrolyte slurry may be casted directly onto a dry positive or negative electrode solid film to form a coating of the electrolyte layer.

All-solid-state batteries comprising at least one electrochemical cell as defined herein are also contemplated in the present document. For example, the all-solid-state battery is a rechargeable battery. In some examples, the all-solid-state battery is a lithium battery or a lithium-ion battery. Also contemplated are uses of the present all-solid-state batteries in mobile devices, such as cell phones, cameras, tablets or laptops, in electric or hybrid vehicles, or in renewable energy storage.

### EXAMPLES

The following non-limiting examples are illustrative embodiments and should not be construed as further limiting the scope of the present invention. These examples will be better understood by referring to the accompanying figures.

Unless otherwise indicated, all numbers expressing quantities of components, preparation conditions, concentrations, properties, etc. used herein shall be understood as being modified in all instances by the term “about.” At the very least, each numerical parameter should at least be construed in light of the number of significant digits reported and by applying standard rounding techniques. Accordingly, unless otherwise indicated, the numerical parameters set forth herein are approximations that may vary depending upon the properties sought to be obtained. Notwithstanding the fact that the numerical ranges and parameters setting forth the broad scope of the embodiments are approximations, the numerical values set forth in the following examples are reported as accurately as possible. However, any numerical value inherently contains some errors resulting from variations in experiments, test measurements, statistical analyses, etc.

The crosslinkable polymer (polymer precursor) used in the following examples is an aprotic poly(ethylene oxide) copolymer comprising acrylate functional groups. The polymer used has a molecular weight of about 8,000 g/mol and is in the liquid phase at 25° C. before crosslinking.

### Example 1

(a) Preparation of the Positive Electrode Film (C-LFP with LLZO)

A powder of C-LFP particles (carbon-coated LiFePO₄, 6.50 g) having an average diameter of 200 nm was mixed with c-LLZO (cubic phase Li₇La₃Zr₂O₁₂, 1.90 g) having an average diameter of 5 μm and carbon black (0.20 g) to form a dry powder mixture. A polymer solution was prepared separately by dissolving LiTFSI (0.16 g), 2,2-dimethoxy-1,2-diphenylethan-1-one (4 mg) as an initiator, and the crosslinkable polymer (0.67 g) in a mixture of toluene (0.31 g) and acetonitrile (1.24 g). The polymer solution was added to the dry powder mixture and mixed using a planetary type centrifugal mixer (Thinky™ ARE-250 mixer). Additional solvent (acetonitrile and toluene in a 8:2 volume ratio) was added to the slurry to achieve an appropriate viscosity (˜10,000 cP) for coating. The resulting thick slurry was applied on a carbon-coated aluminum foil using the doctor blade method. After drying the solvent at 60° C. for 10 minutes, the film was irradiated with UV light in a nitrogen purged atmosphere for 5 minutes.

(b) Preparation and Deposition of the c-LLZO-Polymer Electrolyte (Half-Cell)

c-LLZO (20 g) and the crosslinkable polymer (7.2 g) were mixed in a 100 mL polypropylene vial with 30% of the volume filled with stainless steel balls (1:1 mixture of 1 mm and 3 mm balls) in a glove box. The mixture was then mixed in a high energy ball mill (8000M Mixer/Mill™, SPEX SamplePrep™ LLC) for 2 hours with intermittent breaks to avoid overheating (>60° C.). Additional solvent (acetonitrile and toluene in an 8:2 volume ratio) was added to the slurry to reach an appropriate viscosity (˜10,000 cP) for coating. The initiator 2,2-dimethoxy-1,2-diphenylethan-1-one (36 mg) was added to the slurry and the mixing was resumed for one additional minute. The slurry was then coated on the free surface of the electrode film obtained in (a) and placed under vacuum for 30 minutes to allow the composite electrolyte to infiltrate into the pores. The coated film was then irradiated with UV light in a nitrogen purged atmosphere for 2 minutes. The ceramic-polymer electrolyte layer on the positive electrode had a thickness of 28 μm.

(c) Cell Assembly

The half-cell as prepared in step (b) was placed on a thin film of metallic lithium (about 40 μm) and the cell was pressed at 100 psi for 10 minutes between two plates heated at a temperature of 80° C. The cell was then vacuum sealed in a metallized plastic bag. The active area of the assembled cell was of 4 cm².

(d) Electrochemical Testing

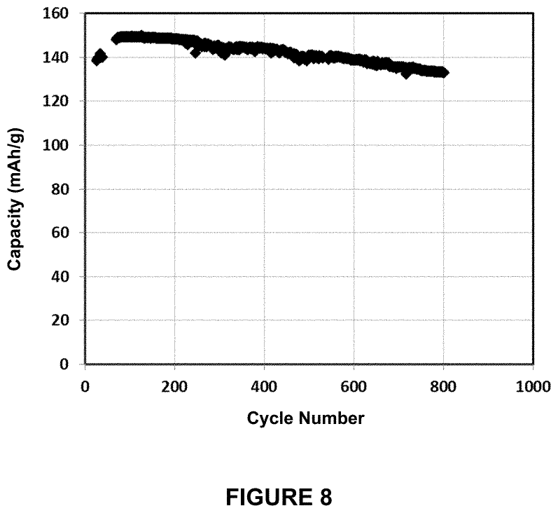

The cell was cycled at 30° C. between 4.0V and 2.0V at a rate of C/12. The same current was applied in charge and discharge. The discharge capacity results of this cell are presented in FIG. 8.

### Example 2

(a) Preparation of the Positive Electrode Film (C-LFP)

A powder of C-LFP particles (6.80 g) having an average diameter of 200 nm was mixed with carbon black (0.20 g). A polymer solution was prepared separately by dissolving LiTFSI (0.32 g), 2,2-dimethoxy-1,2-diphenylethan-1-one (8 mg) and the crosslinkable polymer (1.59 g) in a mixture of toluene (0.74 g) and acetonitrile (2.97 g). The polymer solution was added to the dry powder and the combination was mixed using a planetary type centrifugal mixer (Thinky™ ARE-250 mixer). Additional solvent (acetonitrile and toluene at 8:2 v/v) was added to the slurry to reach an appropriate viscosity (˜10,000 cP) for coating. The slurry was coated on a carbon-coated aluminum foil using a doctor blade. After drying the solvent at 60° C. for 10 minutes, the film was irradiated with UV light in a nitrogen purged atmosphere for 5 minutes.

(b) Preparation and Deposition of the c-LLZO-Polymer Electrolyte (Half-Cell)

c-LLZO (16.67 g) and the crosslinkable polymer in the liquid phase (9.72 g) were mixed in a 100 mL polypropylene vial with 30% of the volume filled with stainless steel balls (1:1 mixture of 1 mm and 3 mm balls) in a glove box. The whole was then mixed in a high energy ball mill (8000M Mixer/Mill™, SPEX SamplePrep™ LLC) for 2 hours with intermittent breaks to avoid overheating (>60° C.). Additional solvent (acetonitrile and toluene at 8:2 v/v) was added to the slurry to reach an appropriate viscosity (˜10,000 cP) for coating. LiTFSI (1.94 g) and 2,2-dimethoxy-1,2-diphenylethan-1-one (49 mg) were added to the slurry and the mixing was resumed for five minutes. The slurry was then coated on the free surface of the electrode film obtained in (a) and placed under vacuum for 30 minutes to allow the composite electrolyte to infiltrate into the pores. The coated film was then irradiated with UV light in a nitrogen purged atmosphere for 2 minutes. The electrolyte layer on the positive electrode had a thickness of 20 μm. The electrolyte film was laminated with the positive electrode by placing the combination of the two layers between two hot plates under 100 psi at 80° C. to complete the formation of the half-cell.

(c) Cell Assembly

A thin film of metallic lithium (about 40 μm) was placed on the half-cell as prepared in step (b) and the cell was laminated at 100 psi at a temperature of 80° C. The cell was then vacuum sealed in a metallized plastic bag. The active area of the assembled cell was 4 cm².

(d) Electrochemical Testing

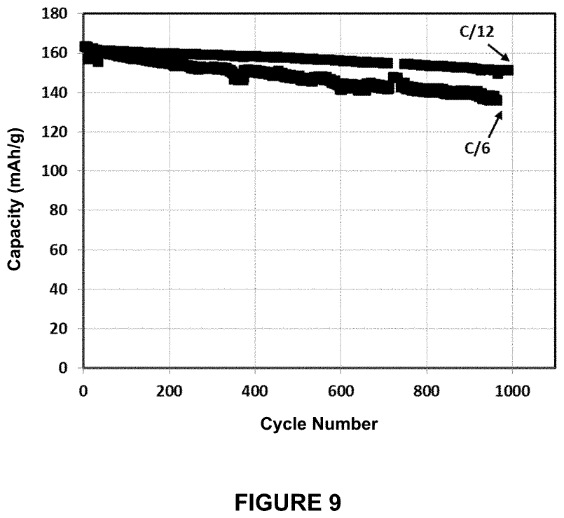

The cell was cycled at 30° C. between 4.0V and 2.0V at rates of C/6 and C/12. The same current was applied in charge and discharge. The discharge capacity results of this cell are presented in FIG. 9.

### Example 3

(a) Preparation of the Positive Electrode Film (NMC)

Carbon black (0.8 g) was dispersed in anhydrous xylene (22.8 g) in the presence of NBR (nitrile-butadiene rubber 1.2 g) by high energy milling for 15 minutes with intermittent breaks to avoid increasing the temperature of the mixture above 60° C. NCM (Li[Ni_{0.6}Co_{0.2}Mn_{0.2}]O₂, 2.0 g) powder having an average particle diameter of 7 μm and argyrodite (Li₆PS₅Cl, 0.71 g) particles having an average diameter of 3 μm were added to 1.77g of the mixture. The combination was then mixed to form a homogeneous slurry. The slurry was casted on a carbon-coated aluminum foil with a doctor blade and dried under vacuum at 120° C. for solvent evaporation. The procedure was carried out under argon with a moisture level of less than 10 ppm.

(b) Preparation and Deposition of the Electrolyte (Half-Cell)

LiTFSI (6 g) was dissolved in the crosslinkable polymer in liquid phase (30 g) with 2,2-dimethoxy-1,2-diphenylethan-1-one (15 mg) in a 300 mL glass bottle by rolling the bottle for 24 hours at room temperature. The solution was casted on the positive electrode film obtained in (a) and placed under vacuum for 1 hour to fill the pores of the electrode material with the liquid phase polymer precursor, which was then crosslinked by UV irradiation under nitrogen for 5 minutes.

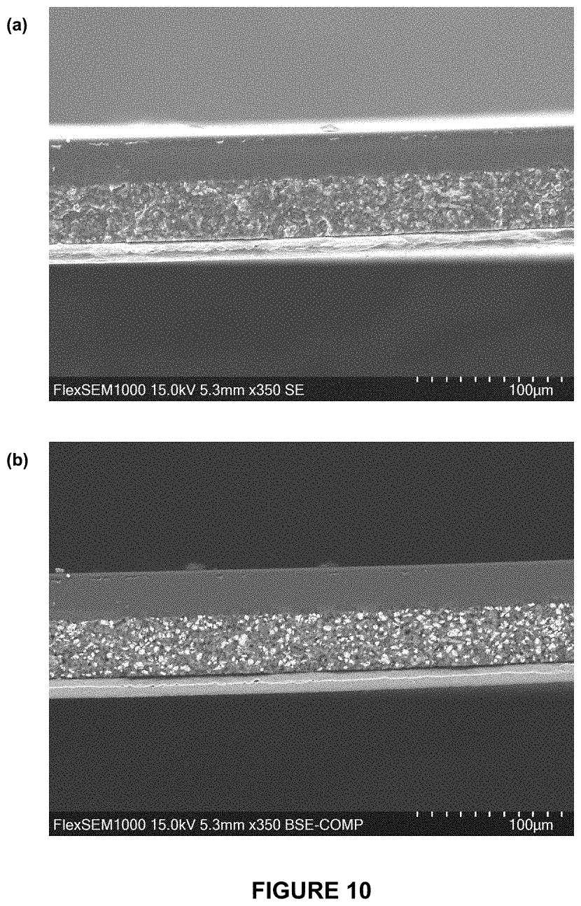

FIG. 10 shows the scanning electron microscopy images of the cross-section of the half-cell in (a) secondary electron mode, and (b) backscattered electron mode, where one can see from bottom to top: the current collector, the positive electrode layer prepared in (a) and comprising the crosslinked polymer infiltrated into the pores, and the crosslinked polymer electrolyte layer.

(c) Cell Assembly

The cell was assembled in a coin cell using the half-cell obtained in (b) and a thin metallic lithium foil (about 40 μm) and pressed at 70° C. under 100 psi.

(d) Electrochemical Testing

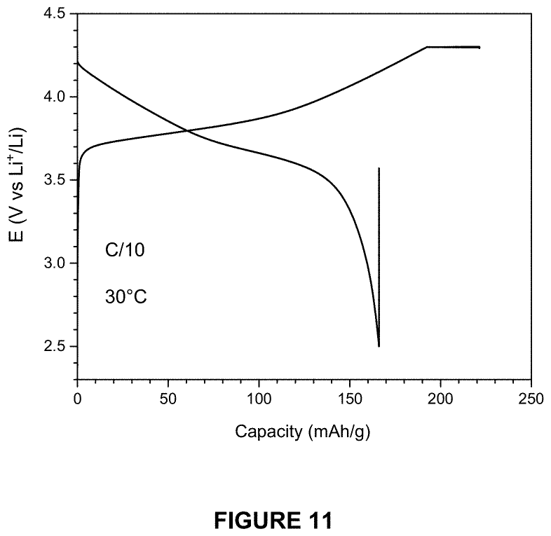

The cell was cycled at 30° C. between 2.5V and 4.3V at a rate of C/10. The same current was applied in charge and discharge. The capacity results for a charge and discharge cycle as a function of the applied current for this cell are presented in FIG. 11.

### Example 4

A half-cell was prepared as in Examples 3(a) and (b). Argyrodite particles (100 mg) having an average diameter of 100 μm were pressed at 300 Mpa between two stainless steel plates. The molded argyrodite pellet was placed between the half-cell and a thin film of metallic lithium (about 40 μm) and pressed at 70° C. under a pressure of 100 psi.

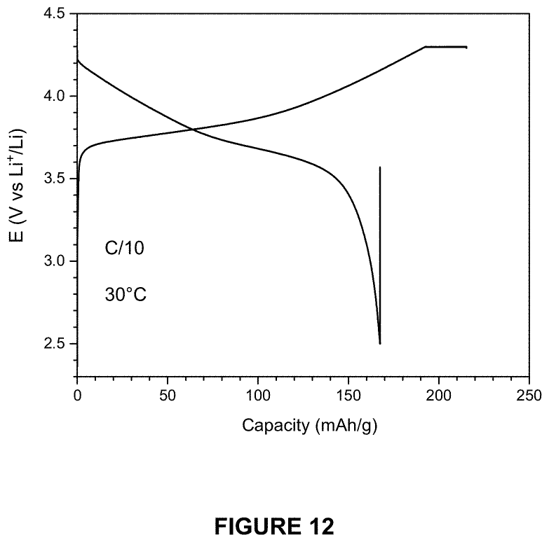

The cell was cycled as in Example 3(d). The capacity results for a charge and discharge cycle as a function of applied current of this cell are presented in FIG. 12.

### Example 5

Argyrodite particles are mixed with the crosslinkable polymer in the liquid phase in a 100 mL polypropylene vial in a glove box. The slurry was mixed in a mixer for 15 minutes with intermittent pauses to avoid overheating. Additional solvent (acetonitrile+toluene at 8:2 v/v) was added to the slurry as needed to reach an appropriate viscosity (˜10,000 cP) for coating. LiTFSI (20% by weight of the polymer) and AIBN (0.5% by weight of the polymer) were added to the slurry and the whole was mixed again for 5 minutes. The slurry was casted on an aluminum foil and placed under vacuum to evaporate the solvent.

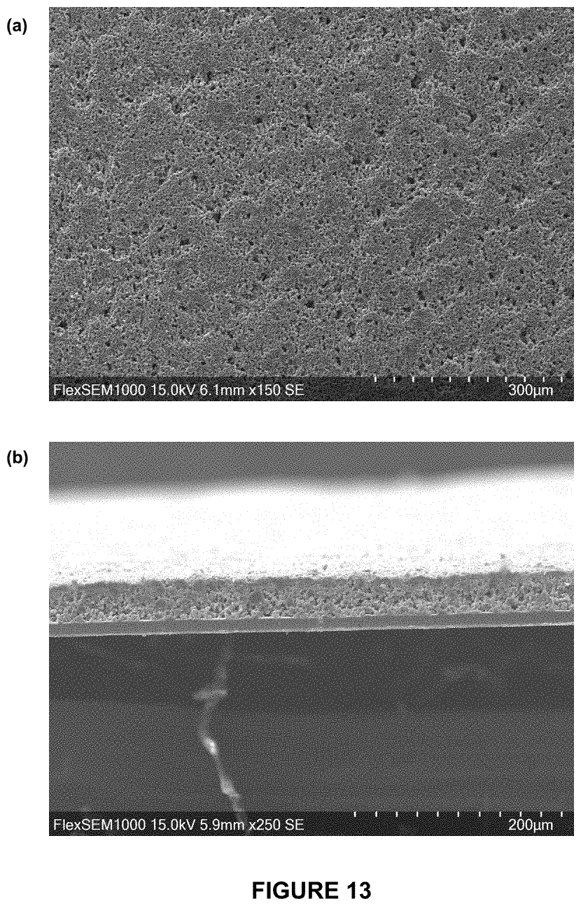

FIG. 13 shows scanning electron microscopy images of (a) the surface (top), and (b) the cross-section, of the electrolyte layer comprising the composite.

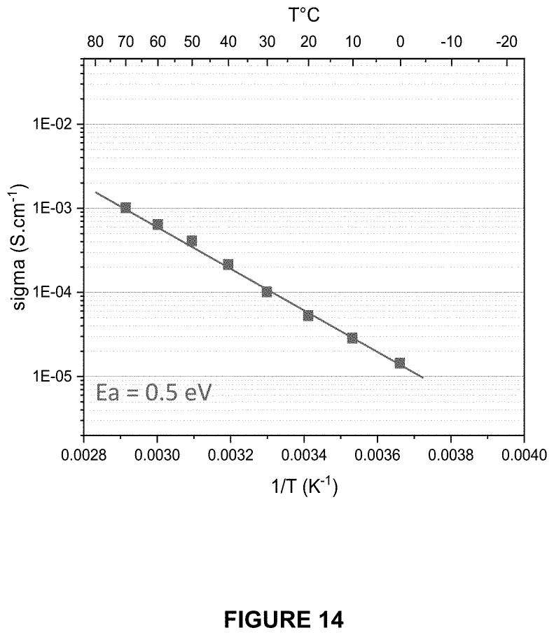

The ionic conductivity was then measured as a function of temperature between 0° C. and 80° C. for the prepared film. The results obtained are presented in FIG. 14.

Numerous modifications could be made to any of the embodiments described above without departing from the scope of the present invention as contemplated. The references, patents or scientific literature documents referred to herein are incorporated by reference in their entirety for all purpose.

1. An all-solid-state electrochemical cell comprising a positive electrode comprising a positive electrode electrochemically active material, a negative electrode comprising a negative electrode electrochemically active material, and an electrolyte between the positive electrode and the negative electrode, wherein:
the positive electrode, the negative electrode and the electrolyte each form a solid layer; and
at least one of the positive electrode, the negative electrode, and the electrolyte comprises a composite material comprising alkali or alkaline earth metal ion-conducting inorganic particles and a crosslinked aprotic polymer, and wherein:
the content of inorganic particles in the composite material is in the range of 50 wt. % to 99.9 wt. %; and
the crosslinked aprotic polymer is in solid form at 25° C. while its polymer precursor before crosslinking is in liquid form at 25° C.

2. The all-solid-state electrochemical cell of claim 1, wherein the inorganic particles comprise an ionically conducting inorganic compound of the amorphous, ceramic or glass-ceramic type, for example, oxide, sulfide or oxysulfide.

3. The all-solid-state electrochemical cell of claim 2, wherein the inorganic particles comprise an oxide, sulfide or oxysulfide compound having a structure selected from garnets, NASICON, LISICON, thio-LISICON, LIPON, perovskite, anti-perovskite, argyrodites, or comprise a compound comprising the element combinations M-P—S, M-P—S—O, M-P—S—X, where M is an alkali or alkaline earth metal, and X is F, Cl, Br, I or a mixture thereof, the element combination optionally including one or more additional elements (metals, metalloids, or non-metals), the compound being in crystalline, amorphous, glass-ceramic form, or a mixture of at least two thereof.

4. The all-solid-state electrochemical cell of claim 2, wherein the inorganic particles comprise at least one compound selected from:
MLZO (such as M₇La₃Zr₂O₁₂, M₍₇₋ₐ₎La₃Zr₂Al_{b}O₁₂, M₍₇₋ₐ₎La₃Zr₂Ga_{b}O₁₂, M₍₇₋ₐ₎La₃Zr_{(2-b)}Ta_{b}O₁₂, M₍₇₋ₐ₎La₃Zr_{(2-b)}NbbO₁₂);
MLTaO (such as M₇La₃Ta₂O₁₂, M₅La₃Ta₂O₁₂, M₆La₃Ta_{1.5}Y_{0.5}O₁₂);
MLSnO (such as M₇La₃Sn₂O₁₂);
MAGP (such as M₁₊ₐAlₐGe₂₋ₐ(PO₄)₃);
MATP (such as M₁₊ₐAlₐTi₂₋ₐ(PO₄)₃);
MLTiO (such as M₃ₐLa_{(2/3-a)}TiO₃);
MZP (such as MₐZr_{b}(PO₄)_{c});
MCZP (such as MₐCa_{b}Zr_{c}(PO₄)_{d});
MGPS (such as MₐGe_{b}P_{c}S_{d}, for example, M₁₀GeP₂S₁₂);
MGPSO (such as MₐGe_{b}P_{c}S_{d}Oₑ);
MSiPS (such as MₐSi_{b}P_{c}S_{d}, for example, M₁₀SiP₂S₁₂);
MSiPSO (such as MₐSi_{b}P_{c}S_{d}Oₑ);
MSnPS (such as MₐSn_{b}P_{c}S_{d}, for example, M₁₀SnP₂S₁₂);
MSnPSO (such as MₐSn_{b}P_{c}S_{d}Oₑ);
MPS (such as MₐP_{b}S_{c}, for example M₇P₃S₁₁);
MPSO (such as MₐP_{b}S_{c}O_{d});
MZPS (such as MₐZn_{b}P_{c}S_{d});
MZPSO (such as MₐZn_{b}P_{c}S_{d}Oₑ);
xM₂S-yP₂S₅;
xM₂S-yP₂S₅-zMX;
xM₂S-yP₂S₅-zP₂O₅;
xM₂S-yP₂S₅-zP₂O₅-wMX;
xM₂S-yM₂O-zP₂S₅;
xM₂S-yM₂O-zP₂S₅-wMX;
xM₂S-yM₂O-zP₂S₅-wP₂O₅;
xM₂S-yM₂O-zP₂S₅-wP₂O₅-vMX;
xM₂S-ySiS₂;
MPSX (such as MₐP_{b}S_{c}X_{d}, for example, M₇P₃S₁₁X, M₇P₂S₈X, M₆PS₅X);
MPSOX (such as MₐP_{b}S_{c}O_{d}Xₑ);
MGPSX (MₐGe_{b}P_{c}S_{d}Xₑ);
MGPSOX (MₐGe_{b}P_{c}S_{d}OₑX_{f});
MSIPSX (MₐSi_{b}P_{c}S_{d}Xₑ);
MSiPSOX (MₐSi_{b}P_{c}S_{d}OₑX_{f});
MSnPSX (MₐSn_{b}P_{c}S_{d}Xₑ);
MSnPSOX (MₐSn_{b}P_{c}S_{d}OₑX_{f});
MZPSX (MₐZn_{b}P_{c}S_{d}Xₑ);
MZPSOX (MₐZn_{b}P_{c}S_{d}OₑX_{f});
M₃OX;
M₂HOX;
M₃PO₄;
M₃PS₄; or
MₐPO_{b}N_{c} (with a=2b+3c−5);
in crystalline, amorphous, glass-ceramic form, or a mixture of at least two thereof;
wherein:
M is an alkali metal ion, an alkaline earth metal ion or a combination thereof, and wherein when M comprises an alkaline earth metal ion, then the number of M is adjusted to achieve electroneutrality;
X is F, Cl, Br, I or a combination thereof;
a, b, c, d, e and f are numbers other than zero and are, independently in each formula, selected to achieve electroneutrality; and
v, w, x, y, and z are numbers other than zero and are, independently in each formula, selected to obtain a stable compound.

5. The all-solid-state electrochemical cell of claim 3 or 4, wherein M is selected from Li, Na, K, Rb, Cs, Be, Mg, Ca, Sr, Ba, or a combination thereof.

6. The all-solid-state electrochemical cell of claim 3 or 4, wherein M is lithium.

7. The all-solid-state electrochemical cell of claim 3 or 4, wherein M comprises Li and at least one of Na, K, Rb, Cs, Be, Mg, Ca, Sr, and Ba.

8. The all-solid-state electrochemical cell of claim 3 or 4, wherein M is Na, K, Rb, Cs, Be, Mg, Ca, Sr, Ba, or a combination thereof.

9. The all-solid-state electrochemical cell of claim 3 or 4, wherein M is Na, K, Mg, or a combination thereof.

10. The all-solid-state electrochemical cell of any one of claims 1 to 9, wherein the crosslinked aprotic polymer is stable at >4V (vs. Li⁺/Li).

11. The all-solid-state electrochemical cell of any one of claims 1 to 10, wherein the crosslinked aprotic polymer comprises at least one aprotic polymer segment selected from polyether, polythioether, polyester, polythioester, polycarbonate, polythiocarbonate, polysiloxane, polyimide, polysulfonimide, polyamide, polysulfonamide, polyphosphazene, and polyurethane segments, or a copolymer or combination of at least two thereof.

12. The all-solid-state electrochemical cell of any one of claims 1 to 10, wherein the crosslinked aprotic polymer comprises at least one aprotic polymer segment comprising a block copolymer with at least two different repeating units to reduce the crystallinity of the crosslinked polymer.

13. The all-solid-state electrochemical cell of claim 12, wherein the aprotic polymer segment comprises, before crosslinking, a block copolymer comprising at least one alkali or alkaline earth metal ion solvating segment and a crosslinkable segment comprising crosslinkable units.

14. The all-solid-state electrochemical cell of claim 13, wherein the alkali or alkaline earth metal ion solvating segment is selected from homo- and copolymers comprising repeating units of Formula (I): 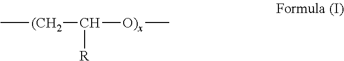
wherein,
R is selected from H, C₁-C₁₀alkyl, and —(CH₂—O—RₐR_{b});
Rₐ is (CH₂—CH₂—O)_{y}; and
R_{b} is a C₁-C₁₀alkyl group.

15. The all-solid-state electrochemical cell of claim 13 or 14, wherein the crosslinkable units comprise functional groups selected from acrylates, methacrylates, allyls, vinyls, and one of their combinations.

16. The all-solid-state electrochemical cell of any one of claims 1 to 14, wherein the composite material forms the electrolyte layer.

17. The all-solid-state electrochemical cell of claim 16, wherein the crosslinked aprotic polymer is present between the inorganic particles.

18. The all-solid-state electrochemical cell of any one of claims 1 to 17, wherein the electrolyte layer further comprises at least one salt, for example comprising a cation of an alkali or alkaline earth metal, and an anion selected from anions hexafluorophosphate (PF₆⁻), bis(trifluoromethanesulfonyl)imide (TFSI⁻), bis(fluorosulfonyl)imide (FSI⁻), (flurosulfonyl)(trifluoromethanesulfonyl)imide ((FSI)(TFSI)⁻), 2-trifluoromethyl-4,5-dicyanoimidazolate (TDI⁻), 4,5-dicyano-1,2,3-triazolate (DCTA⁻), bis(pentafluoroethylsulfonyl)imide (BETI⁻), difluorophosphate (DFP⁻), tetrafluoroborate (BF₄⁻), bis(oxalato)borate (BOB⁻), nitrate (NO₃⁻), chloride (Cl⁻), bromide (Br⁻), fluoride (F⁻), perchlorate (ClO₄⁻), hexafluoroarsenate (AsF₆⁻), trifluoromethanesulfonate (SO₃CF₃⁻) (Tf⁻), fluoroalkylphosphate [PF₃(CF₂CF₃)₃⁻] (FAP⁻), tetrakis(trifluoroacetoxy)borate [B(OCOCF₃)₄]⁻ (TFAB⁻), bis(1,2-benzenediolato (2-)-O,O′)borate [B(C₆O₂)₂]⁻ (BBB⁻), difluoro(oxalato)borate (BF₂(C₂O₄)⁻) (FOB⁻), an anion of the formula BF₂O₄Rₓ⁻ (where Rₓ=C₂₋₄alkyl), and a combination thereof.

19. The all-solid-state electrochemical cell of claim 18, wherein the cation of an alkali or alkaline earth metal of the salt is identical to the alkali or alkaline earth metal present in the inorganic particles.

20. The all-solid-state electrochemical cell of any one of claims 1 to 19, wherein the electrolyte layer further comprises an ionic liquid, for example, comprising a cation selected from imidazolium, pyridinium, pyrrolidinium, piperidinium, phosphonium, sulfonium and morpholinium cations, or from 1-ethyl-3-methylimidazolium (EMI), 1-methyl-1-propylpyrrolidinium (PY₁₃⁺), 1-butyl-1-methylpyrrolidinium (PY₁₄⁺), n-propyl-n-methylpiperidinium (PP₁₃⁺), and n-butyl-n-methylpiperidinium (PP₁₄⁺) cations, and an anion selected from PF₆⁻, BF₄⁻, AsF₆⁻, ClO₄⁻, CF₃SO₃—, (CF₃SO₂)₂N— (TFSI), (FSO₂)₂N⁻ (FSI), (FSO₂)(CF₃SO₂)N⁻, (C₂F₅SO₂)₂N⁻ (BETI), PO₂F₂(DFP), 2-trifluoromethyl-4,5-dicyanoimidazole (TDI), 4,5-dicyano-1,2,3-triazolate (DCTA), bis-oxalato borate (BOB), and (BF₂O₄Rₓ)⁻ (where Rₓ=C₂-C₄alkyl) anions, wherein said ionic liquid is present in an amount such that the electrolyte layer remains in the solid state.

21. The all-solid-state electrochemical cell of any one of claims 1 to 20, wherein the electrolyte layer further comprises an aprotic solvent having a boiling point higher than 150° C., for example, selected from ethylene carbonate (EC), propylene carbonate (PC), gamma-butyrolactone (γ-BL), poly(ethyleneglycol)dimethylether (PEGDME), dimethyl sulfoxide (DMSO), vinylene carbonate (VC), vinyl ethylene carbonate (VEC), 1,3-propylene sulfite, 1,3-propane sultone (PS), triethyl phosphate (TEPa), triethyl phosphite (TEPi), trimethyl phosphate (TMPa), trimethyl phosphite (TMPi), dimethyl methyl phosphonate (DMMP), diethyl ethyl phosphonate (DEEP), tris(trifluoroethyl) phosphate (TFFP), fluoroethylene carbonate (FEC), and one of their mixtures, and wherein said aprotic solvent is present in an amount such that the electrolyte layer remains in the solid state.

22. The all-solid-state electrochemical cell of any one of claims 1 to 21, wherein the positive electrode electrochemically active material comprises a metal oxide, metal sulfide, metal oxysulfide, metal phosphate, metal fluorophosphate, metal oxyfluorophosphate, metal sulfate, metal halide, sulfur, selenium, or a mixture of at least two thereof.

23. The all-solid-state electrochemical cell of claim 22, wherein the metal of the metal oxide, metal sulfide, metal oxysulfide, metal phosphate, metal fluorophosphate, metal oxyfluorophosphate, metal sulfate, or metal halide comprises a metal selected from iron (Fe) titanium (Ti), manganese (Mn), vanadium (V), nickel (Ni), cobalt (Co), aluminum (Al), chromium (Cr), zirconium (Zr), niobium (Nb) and a combination of at least two thereof.

24. The all-solid-state electrochemical cell of claim 23, wherein the metal of the metal oxide, metal sulfide, metal oxysulfide, metal phosphate, metal fluorophosphate, metal oxyfluorophosphate, metal sulfate, or metal halide further comprises an alkali or alkaline earth metal.

25. The all-solid-state electrochemical cell of claim 24, wherein the positive electrode electrochemically active material comprises a lithiated metal oxide, for example, a lithium nickel cobalt manganese oxide (NCM).

26. The all-solid-state electrochemical cell of claim 24, wherein the positive electrode electrochemically active material comprises a lithiated metal phosphate, for example, a lithiated iron phosphate (LiFePO₄).

27. The all-solid-state electrochemical cell of any one of claims 1 to 26, wherein the positive electrode layer further comprises an electronically conducting material comprising at least one of carbon black (for example, Ketjenblack™ or Super P™), acetylene black (for example, Shawinigan black or Denka™ black), graphite, graphene, carbon fibers or nanofibers (for example, vapor grown carbon fibers (VGCFs)), carbon nanotubes (for example, single-wall (SWNT), multi-wall (MWNT)), or metal powders.

28. The all-solid-state electrochemical cell of any one of claims 1 to 27, wherein the positive electrode layer comprises the composite material.

29. The all-solid-state electrochemical cell of claim 28, wherein the crosslinked aprotic polymer is present between the inorganic particles and between the particles of the positive electrode electrochemically active material.

30. The all-solid-state electrochemical cell of any one of claims 1 to 29, wherein the positive electrode layer further comprises a polymer binder selected from the crosslinked aprotic polymers as defined in any one of claims 10 to 15, fluorinated polymers, polyvinylpyrrolidones (PVP), poly(styrene-ethylene-butylene) copolymers (SEB), and synthetic rubbers.

31. The all-solid-state electrochemical cell of claim 30, wherein the polymer binder comprises a fluorinated polymer selected from PVDF, HFP, PTFE, and a copolymer or mixture of two or three of thereof.

32. The all-solid-state electrochemical cell of claim 30, wherein the polymer binder comprises a synthetic rubber selected from SBR (styrene butadiene rubber), NBR (acrylonitrile butadiene rubber), HNBR (hydrogenated NBR), CHR (epichlorohydrin rubber), ACM (acrylate rubber), EPDM (ethylene propylene diene monomer rubber), and a combination thereof, optionally further comprising a carboxyalkylcellulose, a hydroxyalkylcellulose, or a combination thereof.

33. The all-solid-state electrochemical cell of any one of claims 1 to 32, wherein the positive electrode layer further comprises at least one salt, for example comprising a cation of an alkali or alkaline earth metal, and an anion selected from hexafluorophosphate (PF₆⁻), bis(trifluoromethanesulfonyl)imide (TFSI⁻), bis(fluorosulfonyl)imide (FSI⁻), (flurosulfonyl)(trifluoromethanesulfonyl)imide ((FSI)(TFSI)⁻), 2-trifluoromethyl-4,5-dicyanoimidazolate (TDI⁻), 4,5-dicyano-1,2,3-triazolate (DCTA⁻), bis(pentafluoroethylsulfonyl)imide (BETI⁻), difluorophosphate (DFP⁻), tetrafluoroborate (BF₄⁻), bis(oxalato)borate (BOB⁻), nitrate (NO₃⁻), chloride (Cl⁻), bromide (Br⁻), fluoride (F⁻), perchlorate (ClO₄⁻), hexafluoroarsenate (AsF₆⁻), trifluoromethanesulfonate (SO₃CF₃⁻) (Tf⁻), fluoroalkylphosphate [PF₃(CF₂CF₃)₃⁻] (FAP⁻), tetrakis(trifluoroacetoxy)borate [B(OCOCF₃)₄]⁻ (TFAB⁻), bis(1,2-benzenediolato (2-)-O,O′)borate [B(C₆O₂)₂]⁻ (BBB⁻), difluoro(oxalato)borate (BF₂(C₂O₄)⁻) (FOB⁻) anions, an anion of the formula BF₂O₄Rₓ⁻ (where Rₓ=C₂₋₄alkyl), and a combination thereof.

34. The all-solid-state electrochemical cell of claim 33, wherein the alkali or alkaline earth metal cation of the salt is identical to the alkali or alkaline earth metal present in the inorganic particles.

35. The all-solid-state electrochemical cell of any one of claims 1 to 34, wherein the positive electrode layer further comprises an ionic liquid, for example, comprising a cation selected from imidazolium, pyridinium, pyrrolidinium, piperidinium, phosphonium, sulfonium and morpholinium cations, or from 1-ethyl-3-methylimidazolium (EMI), 1-methyl-1-propylpyrrolidinium (PY₁₃⁺), 1-butyl-1-methylpyrrolidinium (PY₁₄⁺), n-propyl-n-methylpiperidinium (PP₁₃⁺), and n-butyl-n-methylpiperidinium (PP₁₄⁺) cations, and an anion selected from PF₆⁻, BF₄⁻, AsF₆⁻, ClO₄⁻, CF₃SO₃⁻, (CF₃SO₂)₂N— (TFSI), (FSO₂)₂N⁻ (FSI), (FSO₂)(CF₃SO₂)N⁻, (C₂F₅SO₂)₂N⁻ (BETI), PO₂F₂⁻ (DFP), 2-trifluoromethyl-4,5-dicyanoimidazole (TDI), 4,5-dicyano-1,2,3-triazolate (DCTA), bis-oxalato borate (BOB), and (BF₂O₄Rₓ)⁻ (where Rₓ=C₂-C₄alkyl) anions, wherein said ionic liquid is present in an amount such that the positive electrode layer remains in the solid state.

36. The all-solid-state electrochemical cell of any one of claims 1 to 35, wherein the positive electrode layer further comprises an aprotic solvent having a boiling point higher than 150° C., for example, selected from ethylene carbonate (EC), propylene carbonate (PC), gamma-butyrolactone (γ-BL), poly(ethyleneglycol)dimethylether (PEGDME), dimethyl sulfoxide (DMSO), vinylene carbonate (VC), vinyl ethylene carbonate (VEC), 1,3-propylene sulfite, 1,3-propane sultone (PS), triethyl phosphate (TEPa), triethyl phosphite (TEPi), trimethyl phosphate (TMPa), trimethyl phosphite (TMPi), dimethyl methyl phosphonate (DMMP), diethyl ethyl phosphonate (DEEP), tris(trifluoroethyl) phosphate (TFFP), fluoroethylene carbonate (FEC), and a mixture thereof, and wherein said aprotic solvent is present in an amount such that the positive electrode layer remains in the solid state.

37. The all-solid-state electrochemical cell of any one of claims 1 to 36, wherein the negative electrode electrochemically active material comprises a metallic film of an alkali or alkaline earth metal or an alloy comprising at least one thereof.

38. The all-solid-state electrochemical cell of claim 37, wherein the alkali or alkaline earth metal is lithium or an alloy comprising lithium.

39. The all-solid-state electrochemical cell of any one of claims 1 to 36, wherein the negative electrode electrochemically active material comprises a metallic film of a non-alkali and non-alkaline earth metal (such as In, Ge, Bi), or an alloy or intermetallic compound thereof (for example, SnSb, TiSnSb, Cu₂Sb, AlSb, FeSb₂, FeSn₂, CoSn₂).

40. The all-solid-state electrochemical cell of any one of claims 36 to 38, wherein the metallic film has a thickness in the range of 5 μm to 500 μm, preferably in the range of 10 μm to 100 μm.

41. The all-solid-state electrochemical cell of any one of claims 1 to 36, wherein the negative electrode electrochemically active material is in the form of particles and has an oxidation-reduction potential lower than that of the positive electrode electrochemically active material.

42. The all-solid-state electrochemical cell of claim 41, wherein the negative electrode electrochemically active material comprises a non-alkali or non-alkaline earth metal (such as In, Ge, Bi), an intermetallic compound (for example, SnSb, TiSnSb, Cu₂Sb, AlSb, FeSb₂, FeSn₂, CoSn₂), a metal oxide, a metal nitride, a metal phosphide, a metal phosphate (such as LiTi₂(PO₄)₃), a metal halide, a metal sulfide, a metal oxysulfide or a combination thereof, or a carbon (such as graphite, graphene, reduced graphene oxide, hard carbon, soft carbon, exfoliated graphite, and amorphous carbon), silicon (Si), silicon-carbon composite (Si—C), silicon oxide (SiOₓ), silicon oxide-carbon composite (SiOₓ—C), tin (Sn), tin-carbon composite (Sn—C), tin oxide (SnOₓ), tin oxide-carbon composite (SnOₓ—C), and a mixture thereof.

43. The all-solid-state electrochemical cell of claim 42, wherein the metal oxide is selected from compounds of the formulae M′_{b}O_{c} (where M′ is Ti, Mo, Mn, Ni, Co, Cu, V, Fe, Zn, Nb or a combination thereof, and b and c are numbers such that the c:b ratio is in the range of 2 to 3, such as MoO₃, MoO₂, MoS₂, V₂O₅, and TiNb₂O₇), spinel oxides M′M″₂O₄(such as NiCo₂O₄, ZnCo₂O₄, MnCo₂O₄, CuCo₂O₄, and CoFe₂O₄) and LiₐM′_{b}O_{c} (where M′ is Ti, Mo, Mn, Ni, Co, Cu, V, Fe, Zn, Nb or a combination thereof, such as a lithium titanate (like Li₄Ti₅O₁₂) or a lithium molybdenum oxide (like Li₂Mo₄O₁₃)).

44. The all-solid-state electrochemical cell of any one of claims 41 to 43, wherein the negative electrode layer further comprises an electronically conducting material comprising at least one of carbon black (for example, Ketjenblack™ or Super P™), acetylene black (for example, Shawinigan black or Denka™ black), graphite, graphene, carbon fibers or nanofibers (for example, vapor grown carbon fibers (VGCFs)), carbon nanotubes (for example, single-wall (SWNT), multi-wall (MWNT)), or metal powders.

45. The all-solid-state electrochemical cell of any one of claims 41 to 44, wherein the negative electrode layer comprises the composite material.

46. The all-solid-state electrochemical cell of claim 45, wherein the crosslinked aprotic polymer is present between the inorganic particles and between the particles of the negative electrode electrochemically active material.

47. The all-solid-state electrochemical cell of any one of claims 41 to 46, wherein the negative electrode layer further comprises a polymer binder selected from the crosslinked aprotic polymers as defined in any one of claims 10 to 15, fluorinated polymers, polyvinylpyrrolidones (PVP), poly(styrene-ethylene-butylene) copolymers (SEB), and synthetic rubbers.

48. The all-solid-state electrochemical cell of claim 47, wherein the polymer binder comprises a fluorinated polymer selected from PVDF, HFP, PTFE, and a copolymer or mixture of two or three thereof.

49. The all-solid-state electrochemical cell of claim 47, wherein the polymer binder comprises a synthetic rubber selected from SBR (styrene butadiene rubber), NBR (acrylonitrile butadiene rubber), HNBR (hydrogenated NBR), CHR (epichlorohydrin rubber), ACM (acrylate rubber), EPDM (ethylene propylene diene monomer rubber), and a combination thereof, optionally further comprising a carboxyalkylcellulose, a hydroxyalkylcellulose, or a combination thereof.

50. The all-solid-state electrochemical cell of any one of claims 41 to 49, wherein the negative electrode layer further comprises at least one salt, for example comprising a cation of an alkali or alkaline earth metal, and an anion selected from hexafluorophosphate (PF₆⁻), bis(trifluoromethanesulfonyl)imide (TFSI⁻), bis(fluorosulfonyl)imide (FSI⁻), (flurosulfonyl)(trifluoromethanesulfonyl)imide ((FSI)(TFSI)⁻), 2-trifluoromethyl-4,5-dicyanoimidazolate (TDI⁻), 4,5-dicyano-1,2,3-triazolate (DCTA⁻), bis(pentafluoroethylsulfonyl)imide (BETI⁻), difluorophosphate (DFP⁻), tetrafluoroborate (BF₄), bis(oxalato)borate (BOB⁻), nitrate (NO₃⁻), chloride (Cl⁻), bromide (Br⁻), fluoride (F⁻), perchlorate (ClO₄⁻), hexafluoroarsenate (AsF₆⁻), trifluoromethanesulfonate (SO₃CF₃⁻) (Tf⁻), fluoroalkylphosphate [PF₃(CF₂CF₃)₃⁻] (FAP⁻), tetrakis(trifluoroacetoxy)borate [B(OCOCF₃)₄]⁻ (TFAB⁻), bis(1,2-benzenediolato (2-)-O,O′)borate [B(C₆O₂)₂]⁻ (BBB⁻), difluoro(oxalato)borate (BF₂(C₂O₄)⁻) (FOB⁻) anions, an anion of the formula BF₂O₄Rₓ⁻ (where Rₓ=C₂₋₄alkyl), and a combination thereof.

51. The all-solid-state electrochemical cell of claim 50, wherein the alkali or alkaline earth metal cation of the salt is identical to the alkali or alkaline earth metal present in the inorganic particles.

52. The all-solid-state electrochemical cell of any one of claims 41 to 51, wherein the negative electrode layer further comprises an ionic liquid, for example, comprising a cation selected from imidazolium, pyridinium, pyrrolidinium, piperidinium, phosphonium, sulfonium and morpholinium cations, or from 1-ethyl-3-methylimidazolium (EMI), 1-methyl-1-propylpyrrolidinium (PY₁₃⁺), 1-butyl-1-methylpyrrolidinium (PY₁₄⁺), n-propyl-n-methylpiperidinium (PP₁₃⁺), and n-butyl-n-methylpiperidinium (PP₁₄⁺) cations, and an anion selected from PF₆⁻, BF₄⁻, AsF₆⁻, ClO₄⁻, CF₃SO₃⁻, (CF₃SO₂)₂N— (TFSI), (FSO₂)₂N⁻ (FSI), (FSO₂)(CF₃SO₂)N⁻, (C₂F₅SO₂)₂N⁻ (BETI), PO₂F₂⁻ (DFP), 2-trifluoromethyl-4,5-dicyanoimidazole (TDI), 4,5-dicyano-1,2,3-triazolate (DCTA), bis-oxalato borate (BOB), and (BF₂O₄Rₓ)⁻ (where Rₓ=C₂-C₄alkyl) anions, wherein said ionic liquid is present in an amount such that the negative electrode layer remains in the solid state.

53. The all-solid-state electrochemical cell of any one of claims 41 to 52, wherein the negative electrode layer further comprises an aprotic solvent having a boiling point higher than 150° C., for example, selected from ethylene carbonate (EC), propylene carbonate (PC), gamma-butyrolactone (γ-BL), poly(ethyleneglycol)dimethylether (PEGDME), dimethyl sulfoxide (DMSO), vinylene carbonate (VC), vinyl ethylene carbonate (VEC), 1,3-propylene sulfite, 1,3-propane sultone (PS), triethyl phosphate (TEPa), triethyl phosphite (TEPi), trimethyl phosphate (TMPa), trimethyl phosphite (TMPi), dimethyl methyl phosphonate (DMMP), diethyl ethyl phosphonate (DEEP), tris(trifluoroethyl) phosphate (TFFP), fluoroethylene carbonate (FEC), and one of their mixtures, and wherein said aprotic solvent is present in an amount such that the negative electrode layer remains in the solid state.

54. The all-solid-state electrochemical cell of any one of claims 1 to 53, further comprising an intermediate layer between the positive electrode layer and the electrolyte layer.

55. The all-solid-state electrochemical cell of any one of claims 1 to 54, further comprising an intermediate layer between the negative electrode layer and the electrolyte layer.

56. The all-solid-state electrochemical cell of claim 54 or 55, wherein the intermediate layer is an alkali or alkaline earth metal-ion conducting polymeric layer, a layer comprising alkali or alkaline earth metal-ion conducting inorganic particles, or a combination thereof.

57. The all-solid-state electrochemical cell of claim 56, wherein the intermediate layer is an alkali or alkaline earth metal-ion conducting polymeric layer (for example, a lithium-ion conducting polymer).

58. A process for the preparation of an all-solid-state electrochemical cell as defined in any one of claims 1 to 57, said process comprising the steps of:
(i) preparing the positive electrode layer comprising the positive electrode electrochemically active material on a current collector;
(ii) preparing the electrolyte layer;
(iii) preparing or providing the negative electrode layer comprising the negative electrode electrochemically active material, optionally on a current collector; and
(iv) assembling the all-solid-state electrochemical cell by combining the positive electrode layer, the electrolyte layer, and the negative electrode layer;
wherein steps (i) to (iii) are carried out in any order and step (iv) is carried out after steps (i) to (iii), or simultaneously with one or two of steps (i) to (iii), or is partly carried out after two of steps (i) to (iii) have been carried out;
wherein at least one of steps (i), (ii) and (iii) further comprises mixing alkali or alkaline earth metal ion-conducting inorganic particles and a polymer precursor and optionally a solvent, wherein said polymer precursor is an aprotic polymer segment comprising crosslinkable units and is in liquid form at 25° C., and crosslinking the crosslinkable units of the polymer precursor, wherein the crosslinked polymer is in solid form at 25° C.; and
wherein the content of inorganic particles in the mixture of particles and polymer precursor is in the range of 50 wt. % to 99.9 wt. %.

59. The process of claim 58, wherein step (i) comprises preparing a positive electrode material mixture comprising the positive electrode electrochemically active material and applying it on a current collector; step (ii) comprises preparing an electrolyte composition and applying the composition on a support; the process comprising assembling the positive electrode layer and the electrolyte layer, and removing the support from the electrolyte layer before or after assembly with the positive electrode layer, optionally followed by the application of pressure and/or heat.

60. The process of claim 59, wherein step (i) further comprises applying an intermediate layer on the positive electrode layer.

61. The process of claim 58, wherein step (i) comprises preparing a positive electrode material mixture comprising the positive electrode electrochemically active material and applying it on a current collector, optionally followed by applying an intermediate layer on the positive electrode layer; and step (ii) comprises preparing an electrolyte composition and applying the composition on the positive electrode layer or on the intermediate layer if present.

62. The process of claim 58, wherein step (ii) comprises preparing an electrolyte composition and applying the composition on a support; and step (i) comprises preparing a positive electrode material mixture comprising the positive electrode electrochemically active material and applying it on the electrolyte layer, optionally preceded by the application of an intermediate layer on the electrolyte layer, wherein the support is removed from the electrolyte layer before or after formation of the positive electrode.

63. The process of any one of claims 59 to 62, wherein the negative electrode electrochemically active material comprises a metallic film and step (iii) comprises preparing the metallic film and applying it on the surface of the electrolyte layer opposite to the positive electrode layer, optionally further comprising forming an intermediate layer on the negative electrode layer or on the electrolyte layer before application.

64. The process of any one of claims 59 to 62, wherein the negative electrode electrochemically active material comprises a material in the form of particles, and step (iii) comprises preparing a negative electrode material mixture comprising the negative electrode electrochemically active material and applying it on the surface of the electrolyte layer opposite to the positive electrode layer, optionally further comprising forming an intermediate layer on the electrolyte layer and applying the negative electrode material mixture on the intermediate layer.

65. The process of any one of claims 59 to 62, wherein the negative electrode electrochemically active material comprises a material in the form of particles, and step (iii) comprises preparing a negative electrode material mixture comprising the negative electrode electrochemically active material and applying it on a current collector to form the negative electrode layer and applying the negative electrode layer on the surface of the electrolyte layer opposite to the positive electrode layer, optionally further comprising forming an intermediate layer on the negative electrode layer or on the electrolyte layer before application.

66. The process of claim 58, wherein step (iii) comprises preparing a negative electrode material comprising the negative electrode electrochemically active material and optionally applying it on a current collector; step (ii) comprises preparing an electrolyte composition and applying the composition on a support, the process comprising assembling the negative electrode layer and the electrolyte layer, and removing the support from the electrolyte layer before or after assembly with the negative electrode layer, optionally followed by the application of pressure and/or heat.

67. The process of claim 66, wherein step (iii) further comprises applying an intermediate layer on the negative electrode layer.

68. The process of claim 58, wherein step (iii) comprises preparing a negative electrode material comprising the negative electrode electrochemically active material and optionally applying it on a current collector, optionally followed by forming an intermediate layer on the negative electrode layer; step (ii) comprising preparing an electrolyte composition and applying it on the negative electrode layer or on the intermediate layer if present.

69. The process of claim 58, wherein step (ii) comprises preparing an electrolyte composition and applying the composition on a support; and step (iii) comprises preparing a negative electrode material comprising the negative electrode electrochemically active material and applying it on the electrolyte layer, optionally preceded by applying an intermediate layer on the electrolyte layer or on the negative electrode layer, wherein the support is removed from the electrolyte layer before or after formation of the negative electrode.

70. The process of any one of claims 66 to 69, wherein step (i) comprises preparing a positive electrode material mixture comprising the positive electrode electrochemically active material and applying on the surface of the electrolyte layer opposite to the negative electrode layer, optionally further comprising forming an intermediate layer on the electrolyte layer and applying the positive electrode material mixture on the intermediate layer.

71. The process of any one of claims 66 to 69, wherein step (i) comprises preparing a positive electrode material mixture comprising the positive electrode electrochemically active material and applying on a current collector to form the positive electrode layer, and applying the positive electrode layer on the surface of the electrolyte layer opposite to the negative electrode layer, optionally further comprising forming an intermediate layer on the positive electrode layer or on the electrolyte layer before the application.

72. The process of any one of claims 66 to 71, wherein the negative electrode electrochemically active material comprises a metallic film and step (iii) comprises preparing the metallic film.

73. The process of any one of claims 66 to 71, wherein the negative electrode electrochemically active material comprises a material in the form of particles, and step (iii) comprises preparing a negative electrode material mixture comprising the negative electrode electrochemically active material before application.

74. The process of any one of claims 64, 65, and 73, wherein the negative electrode material mixture further comprises an electronically conducting material, and optionally a salt, an ionic liquid and/or an aprotic solvent.

75. The process of any one of claims 64, 65, 73 and 74, wherein the negative electrode material mixture further comprises a polymer binder.

76. The process of any one of claims 64, 65, and 73 to 75, wherein the negative electrode material mixture further comprises the alkali or alkaline earth metal ion-conducting inorganic particles, the polymer precursor and optionally a solvent, and step (iii) further comprises crosslinking the polymer precursor after the mixture is applied.

77. The process of any one of claims 64, 65, and 73 to 75, wherein the negative electrode material mixture is a solid mixture further comprising the alkali or alkaline earth metal ion-conducting inorganic particles and step (iii) comprises applying the solid mixture, adding the polymer precursor and optionally a solvent on the applied solid mixture for dispersion of the polymer precursor between the particles, and crosslinking.

78. The process of any one of claims 59 to 77, wherein the electrolyte composition comprises a polymer or polymer precursor, and optionally a salt, an ionic liquid and/or an aprotic solvent.

79. The process of any one of claims 59 to 77, wherein the electrolyte composition comprises the alkali or alkaline earth metal ion-conducting inorganic particles, the polymer precursor and optionally a solvent, and step (ii) further comprises crosslinking the polymer precursor after application of the composition.

80. The process of any one of claims 59 to 77, wherein the electrolyte composition is a solid composition comprising the alkali or alkaline earth metal ion-conducting inorganic particles, and step (ii) comprises applying the solid composition, adding the polymer precursor and optionally a solvent on the applied solid composition for infiltration of the polymer precursor between the particles, and crosslinking the polymer precursor.

81. The process of any one of claims 59 to 77, wherein the positive electrode material mixture further comprises an electronically conducting material, and optionally a salt, an ionic liquid and/or an aprotic solvent.

82. The process of any one of claims 59 to 81, wherein the positive electrode material mixture further comprises a polymer binder.

83. The process of any one of claims 59 to 82, wherein the positive electrode material mixture further comprises the alkali or alkaline earth metal ion-conducting inorganic particles, the polymer precursor and optionally a solvent, and step (iii) further comprises crosslinking the polymer precursor after applying the mixture.

84. The process of any one of claims 59 to 82, wherein the positive electrode material mixture is a solid mixture further comprising the alkali or alkaline earth metal ion-conducting inorganic particles and step (iii) comprises applying the solid mixture, adding the polymer precursor and optionally a solvent on the applied solid mixture for dispersion of the polymer precursor between the particles, and crosslinking.

85. The process of any one of claims 58 to 84, further comprising a photoinitiator, the crosslinking being carried out by UV irradiation, or a thermal initiator, the crosslinking being carried out by heat treatment, or a combination thereof.

86. The process of any one of claims 58 to 84, wherein the crosslinking is carried out by electron beam or another energy source with or without the use of an initiator.

87. An all-solid-state battery comprising at least one all-solid-state electrochemical cell as defined in any of claims 1 to 57.

88. The all-solid-state battery of claim 87, wherein said all-solid-state battery is a rechargeable battery.

89. The all-solid-state battery of claim 87 or 88, wherein said all-solid-state battery is a lithium battery or a lithium-ion battery.

90. The all-solid-state battery of any one of claims 87 to 89, for use in mobile devices, such as cell phones, cameras, tablets or laptops, in electric or hybrid vehicles, or in renewable energy storage.
